(19) United States
(12) Patent Application Publication
(10) Pub. No.: US 2024/0346355 A1
(43) Pub. Date: Oct. 17, 2024

(54) JUNCTION CACHING FOR QUANTUM PROCESSING UNIT MEMORY HIERARCHY

(71) Applicant: Quantinuum LLC, Broomfield, CO (US)

(72) Inventors: Ian Hoffman, Arvada, CO (US); William Cody Burton, Northglenn, CO (US); Curtis Volin, Marietta, GA (US)

(21) Appl. No.: 18/514,115

(22) Filed: Nov. 20, 2023

Related U.S. Application Data
(60) Provisional application No. 63/476,226, filed on Dec. 20, 2022.

(51) Int. Cl. G06N 10/40; G06N 10/20

(52) U.S. Cl. CPC G06N 10/40; G06N 10/20

(57) ABSTRACT

Quantum object confinement apparatus comprising confinement corridors and confinement sites, systems comprising such confinement apparatuses, and corresponding methods are provided. A quantum object confinement apparatus of an example embodiment comprises one or more confinement corridors and one or more confinement sites. Each confinement corridor is defined at least in part by respective corridor sequences of control electrodes. The confinement corridors are configured for transport of one or more quantum objects there along. Each confinement site is defined at least in part by respective site sequences of control electrodes. Each confinement site is coupled to a respective confinement corridor such that one or more quantum objects may be transported from the respective confinement corridor to the confinement site and from the confinement site to the respective confinement corridor.

### CROSS-REFERENCE TO RELATED APPLICATIONS

This application claims priority to U.S. Application No. 63/476,226, filed Dec. 20, 2022, the content of which is incorporated herein in its entirety by reference.

### TECHNICAL FIELD

Various embodiments relate to quantum object confinement apparatuses and methods for routing and sorting quantum objects confined by quantum object confinement apparatuses. For example, various embodiments relate to the use of cache confinement regions coupled to data bus confinement corridors of a quantum object confinement apparatus for performing quantum object routing and/or sorting operations.

### BACKGROUND

In some instances, a quantum object confinement apparatus defines one or more one-dimensional confinement regions. Quantum objects confined by the quantum object confinement apparatus may be transported along the confinement regions. However, when the experiment being performed requires the rearranging of a chain of quantum objects within a one-dimensional confinement region, the sorting of the quantum objects can take a significant amount of time. Through applied effort, ingenuity, and innovation many deficiencies of such quantum object confinement apparatuses and methods of use thereof have been solved by developing solutions that are structured in accordance with the embodiments of the present invention, many examples of which are described in detail herein.

### BRIEF SUMMARY OF EXAMPLE EMBODIMENTS

Example embodiments provide quantum object confinement apparatuses, system comprising quantum object confinement apparatuses, and methods for routing and sorting quantum objects confined by quantum object confinement apparatuses. In various embodiments, a quantum object confinement apparatus comprises one or more one-dimensional confinement regions that are data bus confinement corridors. Each data bus confinement corridor comprises and/or is coupled to one or more quantum operation locations. In various embodiments, a system comprising the quantum object confinement apparatus is configured to perform one or more respective quantum operations on one or more respective quantum objects in each of the quantum operation locations.

In various embodiments, the quantum object confinement apparatus further comprises one or more trapping regions that are respective cache confinement sites. In various embodiments, a cache confinement site is coupled to a data bus confinement corridor via a junction such that quantum objects may be transported from the data bus confinement corridor into the cache confinement site and/or from the cache confinement site to the data bus confinement corridor.

For example, a quantum object that is to have a quantum operation performed thereon in the near future at a particular quantum operation location that is located near a particular cache confinement site may be stored in the particular cache confinement site while other quantum objects are shuttled along the data bus confinement corridor coupling the particular cache confinement site and the particular quantum operation location.

According to one aspect, a quantum object confinement apparatus is provided. In an example embodiment, the quantum object confinement apparatus comprises one or more confinement corridors and one or more confinement sites. Each confinement corridor of the one or more confinement corridors is defined at least in part by respective corridor sequences of control electrodes. The one or more confinement corridors are configured for transport of one or more quantum objects there along. Each confinement site of the one or more confinement sites is defined at least in part by respective site sequences of control electrodes. Each of the one or more confinement sites is coupled to a respective confinement corridor such that one or more quantum objects may be transported from the respective confinement corridor to the confinement site and from the confinement site to the respective confinement corridor.

In an example embodiment, the one or more confinement corridors comprise at least one of (a) one or more data bus confinement corridors configured to provide access to or at least partially define one or more quantum operation locations configured for performance of one or more quantum operations on one or more quantum objects located there at or (b) one or more storage bus confinement corridors configured for storage of quantum objects therein.

In an example embodiment, the one or more confinement sites comprise at least one of (a) one or more cache confinement sites coupled to at least one data bus confinement corridor and disposed between a quantum operation confinement location accessible via the at least one data bus confinement corridor and a storage area of the quantum object confinement apparatus or (b) one or more sorting confinement sites.

In an example embodiment, a confinement site of the one or more confinement sites is coupled to a respective confinement corridor of the one or more confinement corridors via a junction.

In an example embodiment, the confinement site is a dead-end trapping region extending from the junction.

In an example embodiment, a confinement corridor of the one or more confinement corridors is a data bus confinement corridor and a confinement site of the one or more confinement sites is a cache confinement site, a cache transport time is a time used to transport a quantum object between the cache confinement site and a quantum operation location accessible via the data bus confinement corridor, a storage transport time is a time used to transport the quantum object between a storage area of the quantum object confinement apparatus and the quantum operation location, and the cache transport time is less than or equal to a defined fraction of the storage transport time.

In an example embodiment, a layout of the quantum confinement apparatus is configured to reduce perturbations experienced by a quantum object disposed at a confinement site of the one or more confinement sites.

In an example embodiment, the site sequences of control electrodes are configured to generate an electric potential configured to receive one or more quantum objects therein via a single entrance/exit of the confinement site, maintain the one or more quantum objects at the confinement site, provide the one or more quantum objects through the single entrance/exit of the confinement site.

According to another aspect, a method for using a cache confinement site is provided. In an example embodiment, the method comprises causing a quantum object confinement apparatus to confine a plurality of quantum objects, wherein the quantum object confinement apparatus comprises one or more data bus confinement corridors and one or more cache confinement sites. Each data bus confinement corridor of the one or more data bus confinement corridors is defined at least in part by respective corridor sequences of control electrodes. The one or more data bus confinement corridors are configured for transport of one or more quantum objects there along. A first data bus confinement corridor of the one or more data bus confinement corridors providing access to a first quantum operation location. Each cache confinement site of the one or more cache confinement sites is defined at least in part by respective site sequences of control electrodes. A first cache confinement site of the one or more cache confinement sites is coupled to the first data bus confinement corridor such that one or more quantum objects may be transported from the first data bus confinement corridor to the first confinement site and from the first cache confinement site to the first data bus confinement corridor. The one or more quantum objects confined by the quantum object confinement apparatus comprise a first quantum object. The method further comprises performing at least one of (a) causing the first quantum object to be transported from the first cache confinement region to the first quantum operation location via the first data bus confinement corridor, and causing a quantum operation to be performed on at least the first quantum object at the first quantum operation location, or (b) after performance of a quantum operation on the first quantum object at the first quantum operation location, causing the first quantum object to be transported to the first cache confinement region.

In an example embodiment, the method is performed by a controller configured to control one or more components of a system comprising the quantum object confinement apparatus.

In an example embodiment, the quantum object confinement apparatus further comprises at least one storage area accessible via the first data bus confinement corridor, a cache transport time is a time used to transport a quantum object between the first cache confinement site and the first quantum operation location, a storage transport time is a time used to transport the quantum object between the at least one storage area and the first quantum operation location, and the cache transport time is less than or equal to a defined fraction of the storage transport time.

In an example embodiment, the quantum object confinement apparatus comprises one or more storage areas that are coupled to the first data bus confinement corridor and the first cache confinement site is disposed between the first quantum object location and at least one of the one or more storage areas.

In an example embodiment, the first cache confinement site is coupled to the first data bus confinement corridor via a junction.

In an example embodiment, the cache confinement site is a dead-end trapping region extending from the junction.

In an example embodiment, a layout of the quantum confinement apparatus is configured to reduce perturbations experienced by the first quantum object while the first quantum object is disposed at the first cache confinement site.

According to another aspect, a controller is provided. The controller comprises a classical processing device and a classical memory. The controller is configured to execute executable instructions stored in the classical memory using the classical processing device to cause the controller to control one or more components of a system comprising a quantum object confinement apparatus to cause the quantum object confinement apparatus to confine a plurality of quantum objects, wherein the quantum object confinement apparatus comprises one or more data bus confinement corridors and one or more cache confinement sites. Each data bus confinement corridor of the one or more data bus confinement corridors is defined at least in part by respective corridor sequences of control electrodes. The one or more data bus confinement corridors are configured for transport of one or more quantum objects there along. A first data bus confinement corridor of the one or more data bus confinement corridors providing access to a first quantum operation location. Each cache confinement site of the one or more cache confinement sites is defined at least in part by respective site sequences of control electrodes. A first cache confinement site of the one or more cache confinement sites is coupled to the first data bus confinement corridor such that one or more quantum objects may be transported from the first data bus confinement corridor to the first confinement site and from the first cache confinement site to the first data bus confinement corridor. The one or more quantum objects confined by the quantum object confinement apparatus comprise a first quantum object. The controller is further configured to is configured to execute executable instructions stored in the classical memory using the classical processing device to perform at least one of (a) causing the first quantum object to be transported from the first cache confinement region to the first quantum operation location via the first data bus confinement corridor, and causing a quantum operation to be performed on at least the first quantum object at the first quantum operation location, or (b) after performance of a quantum operation on the first quantum object at the first quantum operation location, causing the first quantum object to be transported to the first cache confinement region.

In an example embodiment, the quantum object confinement apparatus further comprises at least one storage area accessible via the first data bus confinement corridor, a cache transport time is a time used to transport a quantum object between the first cache confinement site and the first quantum operation location, a storage transport time is a time used to transport the quantum object between the at least one storage area and the first quantum operation location, and the cache transport time is less than or equal to a defined fraction of the storage transport time.

In an example embodiment, the quantum object confinement apparatus comprises one or more storage areas that are coupled to the first data bus confinement corridor and the first cache confinement site is disposed between the first quantum object location and at least one of the one or more storage areas.

In an example embodiment, the first cache confinement site is coupled to the first data bus confinement corridor via a junction.

In an example embodiment, the cache confinement site is a dead-end trapping region extending from the junction.

In an example embodiment, a layout of the quantum confinement apparatus is configured to reduce perturbations experienced by the first quantum object while the first quantum object is disposed at the first cache confinement site.

According to still another aspect, a system is provided. The system comprises a quantum object confinement apparatus, one or more voltage sources, and a controller configured to control operation of the one or more voltage sources. The quantum object confinement apparatus comprises one or more data bus confinement corridors and one or more cache confinement sites. Each data bus confinement corridor of the one or more data bus confinement corridors is defined at least in part by respective corridor sequences of control electrodes. The one or more data bus confinement corridors are configured for transport of one or more quantum objects there along. A first data bus confinement corridor of the one or more data bus confinement corridors providing access to a first quantum operation location. Each cache confinement site of the one or more cache confinement sites is defined at least in part by respective site sequences of control electrodes. A first cache confinement site of the one or more cache confinement sites is coupled to the first data bus confinement corridor such that one or more quantum objects may be transported from the first data bus confinement corridor to the first confinement site and from the first cache confinement site to the first data bus confinement corridor. The one or more voltage sources are configured to provide respective voltage signals to respective control electrodes of the respective corridor sequences of control electrodes and the respective site sequences of control electrodes. The controller is configured to control operation of the one or more voltage sources to cause the quantum object confinement apparatus to confine a plurality of quantum objects. The one or more quantum objects confined by the quantum object confinement apparatus comprise a first quantum object. The controller is further configured to control operation of the one or more voltage sources to cause the system to perform at least one of (a) causing the first quantum object to be transported from the first cache confinement region to the first quantum operation location via the first data bus confinement corridor, and causing a quantum operation to be performed on at least the first quantum object at the first quantum operation location, or (b) after performance of a quantum operation on the first quantum object at the first quantum operation location, causing the first quantum object to be transported to the first cache confinement region.

In an example embodiment, the quantum object confinement apparatus further comprises at least one storage area accessible via the first data bus confinement corridor, a cache transport time is a time used to transport a quantum object between the first cache confinement site and the first quantum operation location, a storage transport time is a time used to transport the quantum object between the at least one storage area and the first quantum operation location, and the cache transport time is less than or equal to a defined fraction of the storage transport time.

In an example embodiment, the quantum object confinement apparatus comprises one or more storage areas that are coupled to the first data bus confinement corridor and the first cache confinement site is disposed between the first quantum object location and at least one of the one or more storage areas.

In an example embodiment, the first cache confinement site is coupled to the first data bus confinement corridor via a junction.

In an example embodiment, the cache confinement site is a dead-end trapping region extending from the junction.

In an example embodiment, a layout of the quantum confinement apparatus is configured to reduce perturbations experienced by the first quantum object while the first quantum object is disposed at the first cache confinement site.

According to yet another aspect, a method for transporting a first quantum object from an originating location of a quantum object confinement apparatus to a destination location of the quantum object confinement apparatus. In an example embodiment, the method comprises causing transportation of the first quantum object confined by the quantum object confinement apparatus from the originating location of the quantum object confinement apparatus to a sorting confinement site of the quantum object confinement apparatus; causing one or more second quantum objects disposed along a transportation path from the originating location to the destination location to be transported past the sorting confinement site; and causing transportation of the first quantum object from the sorting confinement site to the destination location.

In an example embodiment, the method is performed by a controller configured to control one or more components of a system comprising the quantum object confinement apparatus.

In an example embodiment, the destination location is a quantum operation location or a cache confinement site.

In an example embodiment, the sorting confinement site is selected from a plurality of sorting confinement sites of the quantum object confinement apparatus based at least in part on one or more of the location of the sorting confinement site compared to the transportation path, a number of one or more second quantum objects disposed along the transportation path, or respective locations of the one or more second quantum objects disposed along the transportation path.

In an example embodiment, the sorting confinement site is coupled to at least one of (a) one or more data bus confinement corridors or (b) one or more storage bus confinement corridors.

In an example embodiment, the sorting confinement site is coupled to the to at least one of (a) one or more data bus confinement corridors or (b) one or more storage bus confinement corridors via a junction.

In an example embodiment, the quantum object confinement apparatus comprises one or more confinement corridors, each confinement corridor of the one or more confinement corridors defined at least in part by respective corridor sequences of control electrodes, the one or more confinement corridors configured for transport of one or more quantum objects there along, wherein the originating location and the destination location are accessible via respective ones of the one or more confinement corridors; and one or more sorting confinement sites, each sorting confinement site of the one or more sorting confinement sites defined at least in part by respective site sequences of control electrodes, each respective sorting confinement site of the one or more sorting confinement sites coupled to at least one respective confinement corridor such that one or more quantum objects may be transported from the at least one respective confinement corridor to the respective sorting confinement site and from the respective sorting confinement site to the at least one respective confinement corridor, wherein the one or more sorting confinement sites comprises the sorting confinement site.

According to another aspect, a controller is provided. The controller comprises a classical processing device and a classical memory. The controller is configured to execute executable instructions stored in the classical memory using the classical processing device to cause the controller to control one or more components of a system comprising a quantum object confinement apparatus to cause transportation of the first quantum object confined by the quantum object confinement apparatus from the originating location of the quantum object confinement apparatus to a sorting confinement site of the quantum object confinement apparatus; cause one or more second quantum objects disposed along a transportation path from the originating location to the destination location to be transported past the sorting confinement site; and cause transportation of the first quantum object from the sorting confinement site to the destination location.

In an example embodiment, the destination location is a quantum operation location or a cache confinement site.

In an example embodiment, the sorting confinement site is selected from a plurality of sorting confinement sites of the quantum object confinement apparatus based at least in part on one or more of the location of the sorting confinement site compared to the transportation path, a number of one or more second quantum objects disposed along the transportation path, or respective locations of the one or more second quantum objects disposed along the transportation path.

In an example embodiment, the sorting confinement site is coupled to at least one of (a) one or more data bus confinement corridors or (b) one or more storage bus confinement corridors.

In an example embodiment, the sorting confinement site is coupled to the to at least one of (a) one or more data bus confinement corridors or (b) one or more storage bus confinement corridors via a junction.

In an example embodiment, the quantum object confinement apparatus comprises one or more confinement corridors, each confinement corridor of the one or more confinement corridors defined at least in part by respective corridor sequences of control electrodes, the one or more confinement corridors configured for transport of one or more quantum objects there along, wherein the originating location and the destination location are accessible via respective ones of the one or more confinement corridors; and one or more sorting confinement sites, each sorting confinement site of the one or more sorting confinement sites defined at least in part by respective site sequences of control electrodes, each respective sorting confinement site of the one or more sorting confinement sites coupled to at least one respective confinement corridor such that one or more quantum objects may be transported from the at least one respective confinement corridor to the respective sorting confinement site and from the respective sorting confinement site to the at least one respective confinement corridor, wherein the one or more sorting confinement sites comprises the sorting confinement site.

According to still another aspect, a system is provided. The system comprises a quantum object confinement apparatus, one or more voltage sources, and a controller configured to control operation of the one or more voltage sources. The quantum object confinement apparatus comprises a sorting confinement site and one or more confinement corridors. Each confinement corridor of the one or more confinement corridors defined at least in part by respective corridor sequences of control electrodes and the sorting confinement site is defined at least in part by respective site sequences of control electrodes. The one or more voltage sources are configured to provide respective voltage signals to respective control electrodes of the respective corridor sequences of control electrodes and the respective site sequences of control electrodes. The controller is configured to control operation of the one or more voltage sources to cause the quantum object confinement apparatus to cause transportation of the first quantum object confined by the quantum object confinement apparatus from the originating location of the quantum object confinement apparatus to a sorting confinement site of the quantum object confinement apparatus; cause one or more second quantum objects disposed along a transportation path from the originating location to the destination location to be transported past the sorting confinement site; and cause transportation of the first quantum object from the sorting confinement site to the destination location.

In an example embodiment, the destination location is a quantum operation location or a cache confinement site.

In an example embodiment, the sorting confinement site is selected from a plurality of sorting confinement sites of the quantum object confinement apparatus based at least in part on one or more of the location of the sorting confinement site compared to the transportation path, a number of one or more second quantum objects disposed along the transportation path, or respective locations of the one or more second quantum objects disposed along the transportation path.

In an example embodiment, the sorting confinement site is coupled to at least one of (a) one or more data bus confinement corridors or (b) one or more storage bus confinement corridors.

In an example embodiment, the sorting confinement site is coupled to the to at least one of (a) one or more data bus confinement corridors or (b) one or more storage bus confinement corridors via a junction.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 provides block diagram of an example system comprising a quantum object confinement apparatus, in accordance with an example embodiment.

FIG. 2 provides a top view of at least a portion of an example quantum object confinement apparatus, in accordance with an example embodiment.

FIGS. 3-7 each provide a schematic diagram of at least a portion of a respective example quantum object confinement apparatus, in accordance with an example embodiment.

FIG. 8 provides a flowchart illustrating various processes and/or procedures of a routing operation, the processes and/or procedures performed by a controller of a system comprising a quantum object confinement apparatus comprising one or more cache confinement sites, in accordance with an example embodiment.

FIG. 9 provides a flowchart illustrating various processes and/or procedures of a sorting operation, the processes and/or procedures performed by a controller of a system comprising a quantum object confinement apparatus comprising one or more sorting confinement sites, in accordance with an example embodiment.

FIGS. 9A-9D provide schematic diagrams showing the performance of a sorting operation using a sorting confinement site, in accordance with an example embodiment.

FIG. 10 provides a schematic diagram of an example controller of a system comprising a quantum object confinement apparatus configured for confining quantum objects therein, in accordance with an example embodiment.

FIG. 11 provides a schematic diagram of an example computing entity of a system comprising a quantum object confinement apparatus that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally” and “approximately” refer to within applicable engineering and/or manufacturing tolerances and/or within user measurement capabilities, unless otherwise indicated. Like numbers refer to like elements throughout.

In various scenarios, quantum objects are confined by a quantum object confinement apparatus (also referred to as a confinement apparatus herein). In various embodiments, a quantum object is an ion; atom; ionic, molecular, and/or multipolar molecule; quantum dot; quantum particle; group, crystal, and/or combination thereof (e.g., an ion crystal comprising two or more ions); and/or the like. In an example embodiment where the quantum objects are ions and/or ion crystals, the confinement apparatus is an ion trap, such as a surface ion trap, Paul ion trap, and/or the like. In various other embodiments, the confinement apparatus is an apparatus configured to confine quantum objects and comprises and/or defines one or more data bus corridors and one or more cache confinement sites each coupled to a respective data bus corridor.

In various embodiments, the quantum objects confined by a confinement apparatus are used to perform experiments, controlled quantum state evolution, quantum computations, and/or the like. In various embodiments, the quantum objects are transported between various locations at least partially defined by the confinement apparatus and/or a system comprising the confinement apparatus. For example, the quantum objects may be transported in and/or out of one or more quantum operation locations along one or more data bus confinement corridors. In various embodiments, the quantum objects may be transported in and/or out of one or more storage sites. It may take a significant amount of time (e.g., significantly more time than to perform quantum operations on the quantum objects and/or a non-negligible fraction of the coherence time of the quantum state of the quantum objects) to transport the quantum object between a storage site and a quantum operation location. Transportation of the quantum object may also cause undesired heating of the quantum object.

Additionally, if a plurality of quantum objects is confined by the confinement apparatus, rearranging the quantum objects within the one-dimensional confinement regions (e.g., the data bus confinement corridor, storage confinement corridor, and/or the like) may require a significant number of sorting and/or re-ordering operations. These sorting and/or re-ordering operations also take time and may lead to additional undesired heating of the quantum object. Thus, technical problems exist regarding the efficient routing and sorting of quantum objects confined by a quantum object confinement apparatus.

Embodiments of the present disclosure provide technical solutions to these technical problems. Various embodiments provide confinement apparatuses and/or systems comprising confinement apparatuses that comprise one or more data bus confinement corridors and one or more cache confinement sites and/or sorting confinement sites. Each of the one or more data bus confinement corridors comprises and/or enables one or more quantum objects to be transported into and/or out of one or more quantum operation locations. Each of the cache confinement sites is coupled to a respective data bus confinement corridor such that quantum objects may be transported from the respective data bus confinement corridor into the cache confinement site and/or from the cache confinement site into the data bus confinement corridor. The cache confinement sites enable quantum objects to be stored near the quantum operation locations such that a quantum object may be transported between a quantum operation location and a cache confinement site (or vice versa) faster and with reduced heating (compared to a longer distance transportation operation). Various embodiments therefore provide an improvement to the field of confinement apparatuses and methods relating to and/or including transportation quantum objects confined by confinement apparatuses.

### Exemplary System Comprising a Quantum Object Confinement Apparatus

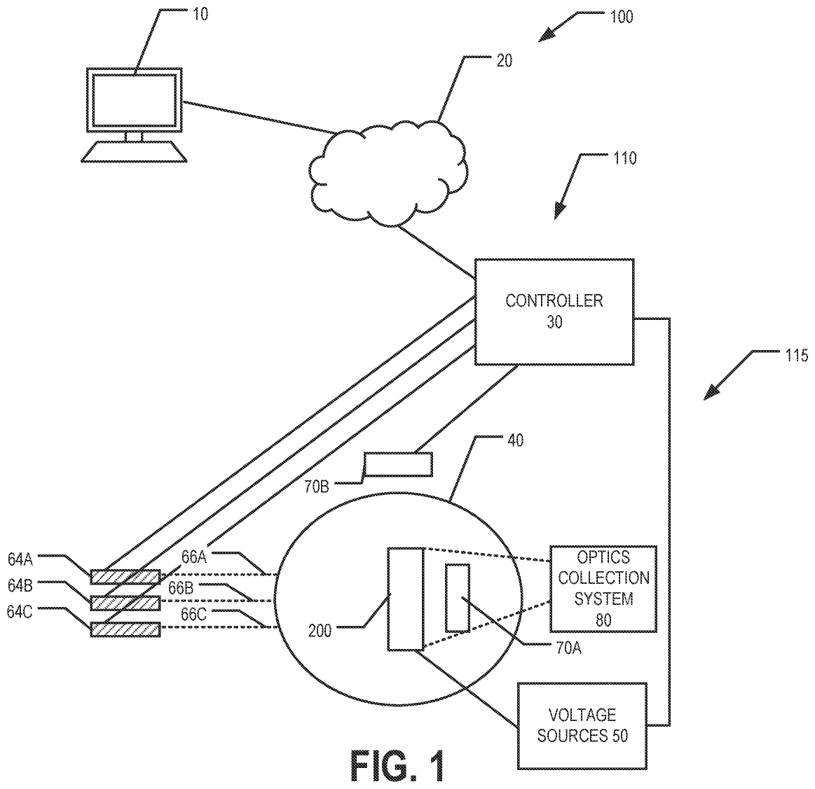

Various embodiments provide a system 100 comprising a quantum object confinement apparatus 200, as shown in FIG. 1. The quantum object confinement apparatus 200 is configured to confine a plurality of quantum objects such that the respective quantum states of the quantum objects may be manipulated, evolved in a controlled manner (e.g., in accordance with a quantum circuit), and/or the like.

For example, quantum operations (one qubit quantum logic gates, two qubit quantum logic gates, initialization, reading/detecting operations, and/or the like) may be performed on quantum objects disposed within quantum operation locations defined by the confinement apparatus 200 and/or system 100 comprising the confinement apparatus. For example, the confinement apparatus 200 is configured to maintain one or more quantum objects at a quantum operation location such that the quantum operation may be performed one the one or more quantum objects. In various embodiments, the system 100 comprising the confinement apparatus 200 comprises one or more manipulation sources 64 (e.g., 64A, 64B, 64C) configured to provide manipulation signals (e.g., laser beams and/or pulses, microwave signals, and/or the like) such that the manipulation signals interact with one or more quantum objects disposed at the quantum operation location. In various embodiments, the system 100 comprising the confinement apparatus 200 comprises one or more magnetic field sources 70 (e.g., 70A, 70B) configured to provide a controlled magnetic field and/or magnetic field gradient at quantum operations locations for use in performing one or more quantum operations on one or more quantum objects disposed at the quantum operation location. In various embodiments, the system 100 comprising the confinement apparatus 200 comprises an optics collection system configured to collect and/or detect light and/or photons emitted by one or more quantum objects disposed at the quantum operation location.

In an example embodiment, the system 100 comprising the confinement apparatus 200 is and/or includes a quantum charge-coupled device (QCCD)-based quantum computer. For example, one or more of the quantum objects confined by the confinement apparatus 200 may be used as qubits of the quantum computer.

In various embodiments, the system 100 comprises a computing entity 10 and a quantum computer 110. In various embodiments, the quantum computer 110 comprises a controller 30 and a quantum processor 115. In various embodiment, the quantum processor 115 comprises a cryostat and/or vacuum chamber 40 enclosing a confinement apparatus 200, one or more manipulation sources 64 (e.g., 64A, 64B, 64C), one or more voltage sources 50, one or more magnetic field sources 70 (e.g., 70A, 70B), an optics collection system 80, and/or the like. In various embodiments, the controller 30 is configured to control the operation of (e.g., control one or more drivers configured to cause operation of) the manipulation sources 64, voltage sources 50, magnetic field sources 70, a vacuum system and/or cryogenic cooling system (not shown), and/or the like. In various embodiments, the controller 30 is configured to receive signals (e.g., electrical signals) generated and provided by the optics collection system 80.

In an example embodiment, the one or more manipulation sources 64 may comprise one or more lasers (e.g., optical lasers, microwave sources and/or masers, and/or the like) or another manipulation source. In various embodiments, the one or more manipulation sources 64 are configured to manipulate and/or cause a controlled quantum state evolution of one or more quantum objects within the confinement apparatus 200. For example, a first manipulation source 64A is configured to generate and/or provide a first manipulation signal and a second manipulation source 64B is configured to generate and/or provide a second manipulation signal, where the first and second manipulation signals are configured to perform one or more quantum operations (single qubit gates, two-qubit gates, cooling, initialization, reading/detection, and/or like) on quantum objects confined by the confinement apparatus.

In an example embodiment, the one or more manipulation sources 64 each provide a manipulation signal (e.g., laser beam and/or the like) to one or more regions of the atomic object confinement apparatus 200 via corresponding beam paths 66 (e.g., 66A, 66B, 66C). In various embodiments, at least one beam path 66 comprises a modulator configured to modulate the manipulation signal being provided to the confinement apparatus 200 via the beam path 66. In various embodiments, the manipulation sources 64, modulator, and/or other components of the quantum computer 110 are controlled by the controller 30.

In various embodiments, the confinement apparatus 200 is an ion trap, such as a surface ion trap, Paul ion trap, and/or the like. In various embodiments, the quantum objects are ions; atoms; ion crystals and/or groups; atomic crystals and/or groups; ionic, molecular, and/or multipolar molecules; quantum dots; quantum particles; groups, crystals, and/or combinations thereof (e.g., ion crystals); and/or the like. In various embodiments, the confinement apparatus 200 is an appropriate confinement apparatus for confining the quantum objects of the embodiment.

In various embodiments, the quantum computer 110 comprises one or more voltage sources 50. For example, the voltage sources may be arbitrary wave generators (AWG), and/or other voltage signal generators. For example, the voltage sources 50 may comprise a plurality of longitudinal voltage drivers and/or voltage sources and/or at least one RF driver and/or voltage source. The voltage sources 50 may be electrically coupled to the corresponding potential generating elements (e.g., control electrodes and/or RF electrodes) of the confinement apparatus 200, in an example embodiment.

In various embodiments, the quantum computer 110 comprises one or more magnetic field sources 70 (e.g., 70A, 70B). For example, the magnetic field source may be an internal magnetic field source 70A disposed within the cryogenic and/or vacuum chamber 40 and/or an external magnetic field source 70B disposed outside of the cryogenic and/or vacuum chamber 40. In various embodiments, the magnetic field sources 70 comprise permanent magnets, Helmholtz coils, electrical magnets, and/or the like. In various embodiments, the magnetic field sources 70 are configured to generate a magnetic field and/or magnetic field gradient at one or more regions of the confinement apparatus 200 that has a particular magnitude and a particular magnetic field direction in the one or more regions of the confinement apparatus 200.

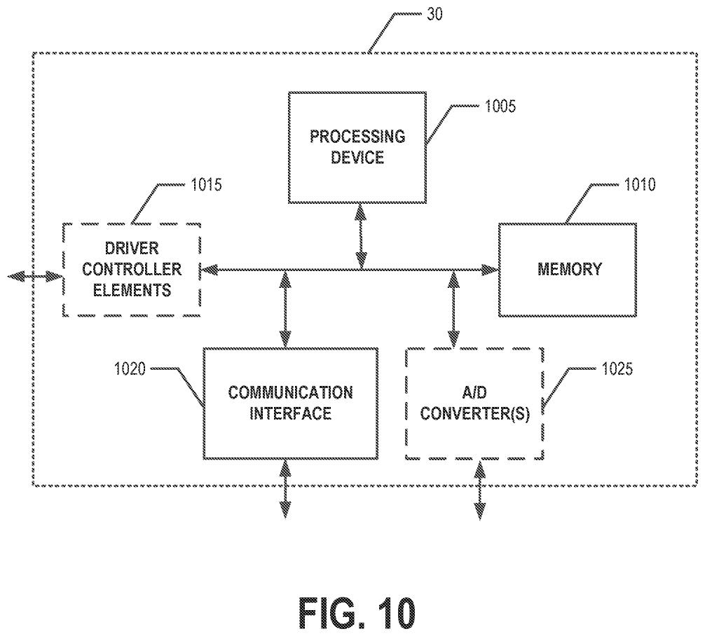

In various embodiments, the quantum computer 110 comprises an optics collection system 80 configured to collect and/or detect photons (e.g., stimulated emission) generated by quantum objects disposed in respective quantum operation locations (e.g., during reading/detection operations). The optics collection system 80 may comprise one or more optical elements (e.g., lenses, mirrors, waveguides, fiber optics cables, and/or the like) and one or more photodetectors. In various embodiments, the photodetectors may be photodiodes, photomultipliers, charge-coupled device (CCD) sensors, complementary metal oxide semiconductor (CMOS) sensors, Micro-Electro-Mechanical Systems (MEMS) sensors, and/or other photodetectors that are sensitive to light at an expected fluorescence wavelength of the quantum objects. In various embodiments, the detectors may be in electronic communication with the controller 30 via one or more A/D converters 1025 (see FIG. 10) and/or the like.

In various embodiments, a computing entity 10 is configured to allow a user to provide input to the quantum computer 110 (e.g., via a user interface of the computing entity 10) and receive, view, and/or the like output from the quantum computer 110. The computing entity 10 may be in communication with the controller 30 of the quantum computer 110 via one or more wired or wireless networks 20 and/or via direct wired and/or wireless communications. In an example embodiment, the computing entity 10 may translate, configure, format, and/or the like information/data, quantum computing algorithms (e.g., quantum circuits), and/or the like into a computing language, executable instructions, command sets, and/or the like that the controller 30 can understand, execute, and/or implement.

In various embodiments, the controller 30 is configured to control the voltage sources 50, magnetic field sources 70, cryogenic system and/or vacuum system controlling the temperature and/or pressure within the cryogenic and/or vacuum chamber 40, manipulation sources 64, and/or other systems controlling various environmental conditions (e.g., temperature, pressure, and/or the like) within the cryogenic and/or vacuum chamber 40, configured to manipulate and/or cause a controlled evolution of quantum states of one or more quantum objects within the confinement apparatus, and/or read and/or detect a quantum (e.g., qubit) state of one or more quantum objects within the confinement apparatus. For example, the controller 30 may cause a controlled evolution of quantum states of one or more quantum objects within the confinement apparatus to execute a quantum circuit and/or algorithm. For example, the controller 30 may read and/or detect quantum states of one or more quantum objects within the confinement apparatus at one or more points during the execution of a quantum circuit. In various embodiments, the quantum objects confined by the confinement apparatus are used as qubits of the quantum computer 110.

### Exemplary Atomic Object Confinement Apparatus

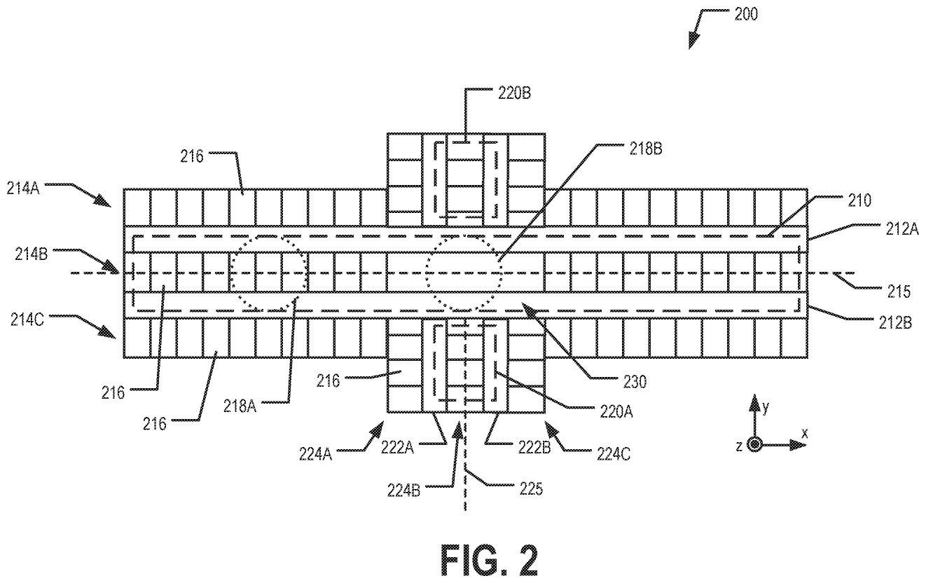

FIG. 2 provides a top view of at least a portion of an example confinement apparatus 200 that may be used to confine one or more quantum objects. For example, in the illustrated embodiment, the confinement apparatus is an ion trap (e.g., a surface ion trap) and the quantum objects are ions and/or ion crystals. In an example embodiment, the confinement apparatus 200 (e.g., surface ion trap) is fabricated as part of an ion trap chip and/or part of an ion trap apparatus and/or package. In an example embodiment, the confinement apparatus 200 is at least partially defined by a number of RF electrodes 212, 222 (e.g., 212A, 212B, 222A, 22B). In various embodiments, the confinement apparatus 200 is at least partially defined by a number of sequences of control electrodes 214, 224 (e.g., 214A, 214B, 214C, 224A, 224B, 224C). Each sequence of control electrodes 214, 224 comprises a plurality of control electrodes 216. In an example embodiment, each control electrode 216 and/or at least a non-empty subset of the control electrodes 216 may be operated independently via the application of control signals thereto. In an example embodiment, at least some of the control electrodes 216 are operated via application of a broadcast control signal. In an example embodiment, the confinement apparatus 200 is a surface Paul trap with symmetric RF electrodes 212, 222. In various embodiments, the RF electrodes 212, 222 and the control electrodes 216 generate potentials and/or fields that are experienced by quantum objects within respective confinement regions of the confinement apparatus 200. In particular, the RF electrodes 212, 222 may be configured to define the respective confinement regions of the confinement apparatus 200 and the control electrodes 216 may be configured to at least partially control movement and/or motion of quantum objects within the respective confinement regions.

In various embodiments, the respective confinement regions comprise one or more data bus confinement corridors 210. In an example embodiment, a data bus confinement corridor 210 is at least partially defined by one or more bus RF electrodes 212 (e.g., 212A, 212B) and/or one or more corridor sequences of control electrodes 214 (e.g., 214A, 214B, 214C). In various embodiments, the data bus confinement corridor 210 includes and/or provides access to one or more quantum operation locations 218 (e.g., 218A, 218B). In various embodiments, the one or more bus RF electrodes 212 and/or the corridor sequences of control electrodes 214 define a bus axis 215.

In various embodiments, the respective confinement regions comprise one or more cache confinement sites 220 (e.g., 220A, 220B). In an example embodiment, a cache confinement site 220 is at least partially defined by one or more cache site RF electrodes 222 (e.g., 222A, 222B) and/or one or more cache site sequences of control electrodes 224 (e.g., 224A. 224B, 224C). In various embodiments, the cache site RF electrodes 222 and/or cache site sequences of control electrodes 224 define a site axis 225.

In various embodiments, the site axis 225 is transverse to the bus axis 215. In various embodiments, the cache confinement site 220 is coupled to a data bus confinement corridor 210 such that one or more quantum objects can be transported from the data bus confinement corridor 210 into the cache confinement site 220 and/or from the cache confinement site 220 into the data bus confinement corridor 210. For example, the data bus confinement corridor 210 and the cache confinement site 220 are coupled to one another via a junction 230, in an example embodiment.

In an example embodiment, the cache site sequences of control electrodes 224 are configured to form at most one potential well. In an example embodiment, the cache site sequences of control electrodes 224 are configured to form one or more potential wells. In an example embodiment, a cache confinement site has a single entrance/exit. For example, the quantum objects are only able to enter or exit the cache confinement site 220 via the junction 230. In various embodiments, each cache site sequence of control electrodes 224 comprises fewer control electrodes 216 than a corridor sequence of control electrodes 214. In various embodiments, the cache confinement site 220 is located such that a quantum object may be moved from the cache confinement site 220 to at least one quantum operation location 218 (and/or from the at least one quantum operation location 218 to the cache confinement site 220) in a shorter amount of time than transporting a quantum object between the at least one quantum operation location 218 and a storage area of the confinement apparatus.

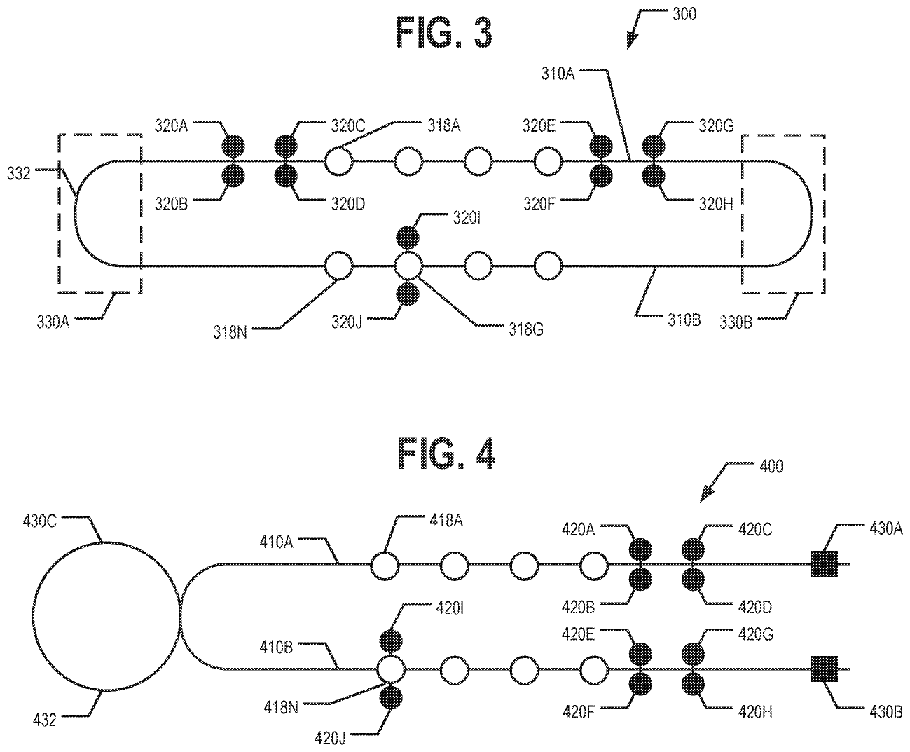

As shown in FIGS. 3-7, in various embodiments, the confinement apparatus comprises storage areas (e.g., 330A, 330B, 430A, 430B, 430C, 530A, 530B, 630, 730). The storage areas are used to store quantum objects in a manner where the quantum state of the quantum object is maintained while quantum operations are performed on other quantum objects. For example, the storage areas may be distant from the quantum operation locations such that the quantum states of the quantum objects disposed in the storage area are less likely to be perturbed as a result of quantum operations being performed on other quantum objects at the quantum operation locations. For example, the storage areas and the cache confinement sites may form a memory hierarchy where the quantum objects disposed at the cache confinement sites are more retrievable on a faster time scale than the quantum objects disposed in the storage areas.

For example, a cache transport time the is the time required to transport a quantum object from a cache confinement site to a quantum operation location (or vice versa). A storage transport time tₛ is the time required to transport a quantum object from a storage area to a quantum operation location (or vice versa). In various embodiments, the storage transport time tₛ is an average time required to transport a quantum object from a storage area (which may include a storage bus confinement corridor, rather than being a single site) to a quantum operation location.

In various embodiments, the cache transport time is at most a defined fraction x of the storage transport time (e.g., t_{c}≤xtₛ, where 0<x<1). In various embodiments, the defined fraction x is 0.9, 0.8, 0.75, 0.7, 0.6, 0.5, 0.4, 0.3, 0.25, 0.2, 0.1 and/or the like. For example, for the example embodiment illustrated in FIG. 3, the defined fraction x is 0.6. For example, for cache confinement site 320C and quantum operation location 318A, t_{c}≤0.2tₛ. For cache confinement site 320A and quantum operation location 318A, t_{c}≤0.5tₛ. For cache confinement site 320I and quantum operation location 318G, t_{c}≤0.1tₛ. Thus, for the example embodiment illustrated in FIG. 3, t_{c}≤0.6tₛ.

In various embodiments, transport and/or maintaining the quantum objects within the storage areas includes the use of one or more broadcast voltage signals to control the electric potential in the storage areas. For example, the corridor sequences of control electrodes 214 are configured to be operated (e.g., have voltage signals applied thereto) that cause the performance of parallel transportation operations at a plurality of positions within the storage areas. For example, broadcast voltage signals are voltage signals that are applied to a plurality of control electrodes 216 that correspond to two or more sequences of control electrodes 214. For example, a broadcast voltage signal may be applied to a particular control electrode 216 to the right of the junction 230 in FIG. 2 and to another control electrode 216 (possibly in the same relative position of the bus) to the left of the junction 230. These parallel transportation operations enable the performance of sorting of the quantum objects located in the storage areas.

The electric potential of a cache confinement site is controlled independently of the electric potential of the storage areas. For example, the cache site sequences of control electrodes 224 are configured to have voltage signals applied thereto that are independent of the voltage signals applied to the corridor sequences of control electrodes or the sequences of control electrodes of the storage areas. For example, the cache confinement sites are configured to not participate in the bulk sorting operations of the storage areas that are performed via the parallel transport operations. This enables the quantum objects at a cache confinement site to be retained nearby to the quantum operation sites while the quantum objects in the storage area are rearranged via parallel transport operations. In this way, there is a hierarchy of quantum object storage locations, with the quantum objects disposed at cache confinement sites being sorted independently of the quantum objects disposed in the storage areas and/or the data bus confinement corridors.

In various embodiments, the upper surface of the confinement apparatus 200 has a planarized topology. For example, the upper surface of each RF electrode 212, 222 of the number of RF electrodes 212, 222 and the upper surface of each control electrode 216 of the number of sequences of control electrodes 214, 224 may be substantially coplanar.

In some embodiments, each of the control electrodes 216 of the number of sequences of control electrodes 214 can be formed with substantially coplanar upper surfaces that are substantially coplanar with the upper surfaces of the RF electrodes 212.

In various embodiments, RF signals may be applied to the RF electrodes 212, 222 to generate an electric and/or magnetic field that acts to maintain one or more quantum objects (e.g., ions) confined by the confinement apparatus 200 in directions transverse to the respective axis 215, 225 of the confinement region. In various embodiments, control signals and/or voltages are applied to the control electrodes 216 to generate a desired electric potential field within the respective confinement region. For example, in various embodiments, time-dependent, time-varying, time evolving, and/or non-static direct current (DC) voltages may be applied to the control electrodes 216 to generate a time-dependent, time-varying, time evolving, and/or non-static electric potential field that causes the quantum objects confined by the confinement apparatus 200 to traverse corresponding trajectories to within the respective confinement regions. For example, the quantum objects may be moved between various zones of the confinement apparatus 200 such that various functions may be performed thereon (e.g., within the quantum operation locations 218) and/or stored for later use.

In various embodiments, the control signals and/or voltages applied to the control electrodes 216 are controlled by one or more connected devices (e.g., a controller 30 as shown in FIG. 10 and/or the like) via leads. For example, depending on the electric monopole and/or dipole (or higher magnitude pole) strength (e.g., electric charge in the case of an electric monopole) of the quantum object, control voltages may be raised or lowered for control electrodes 216 in the vicinity of a particular one or more quantum objects to cause the particular one or more quantum objects to traverse a desired trajectory. For example, a controller 30 may control a voltage driver (e.g., of the voltage sources 50) to cause the voltage driver to apply control signals and/or longitudinal voltages to the control electrodes to generate a time-dependent electric potential (e.g., an electric potential that evolves, changes, and/or varies with time) that causes the quantum objects within the confinement apparatus 200 to traverse desired trajectories.

Depending on such factors as the electric monopole and/or dipole (or higher magnitude pole) strength (e.g., electric charge in the case of an electric monopole) of the quantum objects and/or the shape and/or magnitude of the combined electrical and/or magnetic fields, the quantum objects can be stabilized at a particular distance (e.g., approximately 20 μm to approximately 200 μm) above an upper surface of the confinement apparatus 200 (e.g., the coplanar upper surface of the sequences of control electrodes 214, 224 and RF electrodes 212, 222). To further contribute to controlling the transit of atomic objects along desired trajectories, the confinement apparatus 200 may be operated within a cryogenic and/or vacuum chamber capable of cooling the confinement apparatus 200 to a temperature of less than 124 Kelvin (e.g., less than 100 Kelvin, less than 50 Kelvin, less than 10 Kelvin, less than 5 Kelvin, and/or the like), in various embodiments.

In various embodiments, the RF electrodes 212, 222, the sequences of control electrodes 214, 224 and/or the confinement potential generated by the RF electrodes and/or the sequences of electrodes define the confinement regions (e.g., data bus confinement corridor(s) 210, cache confinement sites 220) of the confinement apparatus 200. In an example embodiment, the bus RF electrodes 212, and/or the confinement potential generated by the corridor RF electrodes 212 define a data bus confinement corridor 210 of the confinement apparatus 200 and the control electrodes 216 of the corridor sequences of control electrodes 214 control the movement and/or positioning of the quantum objects within the data bus confinement corridor. In an example embodiment, the cache site RF electrodes 222, and/or the confinement potential generated by the cache site RF electrodes 222 define a cache confinement site 220 of the confinement apparatus 200 and the control electrodes 216 of the cache site sequences of control electrodes 214 control the movement and/or positioning of the quantum objects within the cache confinement site.

While FIG. 2 illustrates the quantum object confinement apparatus 200 as a surface ion trap, in various embodiments, quantum object confinement apparatus is a 3D ion trap or other quantum object confinement apparatus. In an example embodiment, the quantum object confinement apparatus is a 3D wafer trap configured for confining quantum objects such as ions. In an example embodiment, the quantum object confinement apparatus is a 3D trap where the confinement corridors (e.g., data bus confinement corridors and/or storage bus confinement corridors) are located on a plane (or a set of (substantially) parallel planes) and the confinement sites (e.g., cache confinement sites and/or sorting confinement sites) are disposed out of the plane (or out of each plane of the set of (substantially) parallel planes). For example, a quantum object may be moved to a confinement site from a confinement corridor by moving the quantum object in the vertical direction (e.g., a direction normal/perpendicular to the plane or to each plane of the set of (substantially) parallel planes).

In various embodiments the cache confinement sites are configured to store a quantum object thereat for a significant period of time (e.g., up to the coherence time of the quantum state of the quantum object or possibly longer) with high fidelity. For example, in various embodiments, the cache confinement sites are positioned in the confinement apparatus such that it is unlikely that stray fields (e.g., reflected and/or diffracted manipulation signals, photons emitted by other quantum objects confined by the confinement apparatus, and/or the like) will interact with quantum objects disposed at the cache confinement sites. In another example, traces, vias, and/or the like formed in the chip on which the confinement apparatus is formed do not pass under and/or come within a minimum distance from respective cache confinement sites. For example, the sub-surface routing of various signals is configured and/or designed to reduce the likelihood of stray fields at the cache confinement sites. In an example embodiment, the magnetic field at the cache confinement sites is controlled to have a particular amplitude and/or direction. For example, the confinement apparatus is configured to reduce and/or minimize perturbations experienced by the quantum objects disposed at the cache confinement sites.

FIGS. 3-7 provides schematic diagrams of at least portions of various confinement apparatuses 300, 400, 500, 600, 700. Each of the confinement apparatuses 300, 400, 500, 600, 700 comprises one or more data bus confinement corridors and one or more cache confinement sites. The one or more data bus confinement corridors comprise and/or provide access to one or more quantum operation locations. In various embodiments, the confinement apparatuses 300, 400, 500, 600, 700 comprise one or more storage areas. In various embodiments, a storage area does not include and/or does not provide access to a quantum operation location. For example, a quantum operation location is not accessible directly from a storage area. For example, a quantum object needs to be transported along at least a portion of a data bus confinement corridor to access a quantum operation location from a storage area. In various embodiments, each of the storage areas comprises one or more storage bus confinement corridors and/or sorting confinement sites. In various embodiments, the electrode layout of a storage bus confinement corridor is similar to that of a data bus confinement corridor and/or the electrode layout of a sorting confinement site is similar to that of a cache confinement site.

For example, FIG. 3 illustrates an example confinement apparatus 300. The confinement apparatus 300 comprises first and second data bus confinement corridors 310A. 310B. Each of the first and second data bus confinement corridors 310A, 310B extend from a first storage area 330A to a second storage area 330B. In the illustrated embodiment, the first storage area 330A comprises a storage bus confinement corridor 332 that connects a first end of the first data bus confinement corridor 310A to a first end of the second data bus confinement corridor 310B. Similarly, the second storage area 330B comprises a storage confinement corridor that connects a second end of the first data bus confinement corridor 310A to a second end of the second data bus confinement corridor 310B.

A plurality of quantum operation locations 318 (e.g., 318A, 318G, 318N represented by the open circles) are each disposed along a respective one of the first and second data bus confinement corridors 310A, 310B. Each of the quantum operation locations 318 are configured to have one or more quantum operations performed on one or more quantum objects located thereat.

The confinement apparatus 300 further comprises a plurality of cache confinement sites 320 (e.g., 320A-320J represented by the filled circles). In various embodiments, the cache confinement sites 320 are coupled to the data bus confinement corridors 310 via junctions. For example, the cache confinement sites 320 are “dead end” trapping regions coupled to the respective data bus confinement corridor 310 via a junction. In various embodiments, a junction is where two or more trapping regions meet. In various embodiments, at least one of the two or more trapping regions is not parallel or anti-parallel to at least one other of the two or more trapping regions that meet at the junction.

Each of the cache confinement sites 320 are disposed near at least one of the quantum operation locations 318. For example, the distance between a cache confinement site 320 and at least one quantum operation location 318 is less than the distance between at least one storage area 330 and at least one quantum operation location 318. For example, the storage areas 330 and the cache confinement sites 320 form a memory hierarchy where the quantum objects disposed at the cache confinement sites 320 are retrievable (e.g., can be transported to a quantum operation location 318) on a faster time scale than the quantum objects disposed in the storage areas 330. Similarly, quantum objects can be transported from a quantum operation location 318 to a cache confinement site 320 on a faster time scale than transporting the quantum object to from the quantum operation location 318 to a storage area 330.

For example, a cache transport time t_{c} is the time required to transport a quantum object from a cache confinement site 320 to a quantum operation location 318 (or vice versa). A storage transport time tₛ is the time required to transport a quantum object from a storage area 330 to a quantum operation location 318 (or vice versa). In various embodiments, the storage transport time tₛ is an average time required to transport a quantum object from a storage area 330 (which may include a storage bus confinement corridor 332, rather than being a single site) to a quantum operation location 318. In various embodiments, the cache transport time is at most (e.g., less than or equal to) a defined fraction x of the storage transport time (e.g., t_{c}≤xtₛ, where 0<x<1). In various embodiments, the defined fraction x is 0.9, 0.8, 0.75, 0.7, 0.6, 0.5, 0.4, 0.3, 0.25, 0.2, 0.1 and/or the like. For example, for the example embodiment illustrated in FIG. 3, the defined fraction x is 0.6. For example, for cache confinement site 320C and quantum operation location 318A, t_{c}≤0.2tₛ. For cache confinement site 320A and quantum operation location 318A, t_{c}≤0.5tₛ. For cache confinement site 320I and quantum operation location 318G, t_{c}≤0.1tₛ.

Additionally, the cache confinement sites 320 are configured to be controlled independently of the storage areas 330 and the data bus confinement corridors 310. For example, the respective electric potentials of the cache confinement sites 320 are controlled independently of the electric potential of the storage areas 330 and/or the data bus confinement corridors 310. This enables the quantum objects at the respective cache confinement sites 320 to be retained nearby to the quantum operation location 318 while the quantum objects in the storage area 330 and/or data bus confinement corridor are rearranged (e.g., via parallel transport operations). In various embodiments, the independent control of the electric potential and/or transport operations performed at (and/or into or out of) the cache confinement sites 320 enables the timely transport of quantum objects stored in the cache confinement sites 320 to the quantum operation location 318. In this way, there is a hierarchy of quantum object storage locations, with the quantum objects disposed at cache confinement sites being sorted independently of the quantum objects disposed in the storage areas and/or the data bus confinement corridors.

For example, the confinement apparatus 300 is an elliptical or cyclic confinement apparatus. For example, the confinement apparatus 300 is referred to as cyclic because quantum objects can be continuously cycled and/or transported around the confinement apparatus 300 (if so desired).

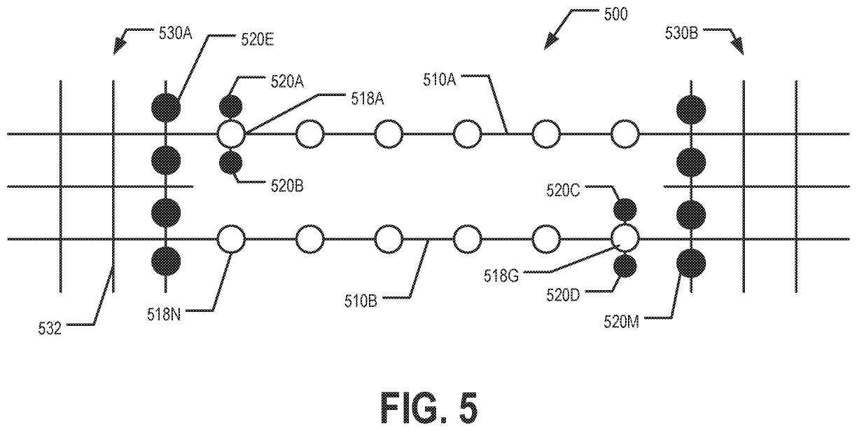

FIG. 4 illustrates another example confinement apparatus 400. The confinement apparatus 400 comprises first and second data bus confinement corridors 410A, 410B. Each of the first and second data bus confinement corridors 410A, 410B extend from a cyclic storage area 430C to first and second storage areas 430A, 430B (represented by filled squares). In various embodiments, the cyclic storage area 430C comprises a storage bus confinement corridor 432 that enables quantum objects to be cyclically and/or continuously cycled and/or transported therearound (if so desired).

The first and second data bus confinement corridors 410A, 410B are coupled to the cyclic storage area 430C such that quantum objects may be transported between the first data bus confinement corridor and the cyclic storage area 430C (or vice versa) and between the second data bus confinement corridor and the cyclic storage area 430C (or vice versa). In an example embodiment, quantum objects may be transported directly from the first data bus confinement corridor 410A to the second data bus confinement corridor 410B (or vice versa).

The confinement apparatus further comprises a plurality of quantum operation locations 418 (e.g., 418A-418N represented by the open circles) coupled to and/or accessible to quantum objects via a respective one of the first or second data bus confinement corridor 410A, 410B. In the illustrated embodiment, the plurality of quantum operation locations 418 each disposed along a respective one of the first and second data bus confinement corridors 410A. 410B. Each of the quantum operation locations 418 are configured to have one or more quantum operations performed on one or more quantum objects located thereat (e.g., via application of one or more manipulation signals, magnetic field gradients, and/or the like).

The confinement apparatus 400 further comprises a plurality of cache confinement sites 420 (e.g., 420A-420J represented by the filled circles). In various embodiments, the cache confinement sites 420 are coupled to the data bus confinement corridors 410 via junctions. For example, the cache confinement sites 420 are “dead end” trapping regions coupled to the respective data bus confinement corridor 410 via a junction.

Each of the cache confinement sites 420 are disposed near at least one of the quantum operation locations 418. For example, the distance between a cache confinement site 420 and at least one quantum operation location 418 is less than the distance between at least one storage area 430 and at least one quantum operation location 418. For example, the storage areas 430 and the cache confinement sites 420 form a memory hierarchy where the quantum objects disposed at the cache confinement sites 420 are retrievable (e.g., can be transported to a quantum operation location 418) on a faster time scale than the quantum objects disposed in the storage areas 430. Similarly, quantum objects can be transported from a quantum operation location 418 to a cache confinement site 420 on a faster time scale than transporting the quantum object to from the quantum operation location 418 to a storage area 430. Furthermore, by moving the quantum object out of the data bus confinement corridor 410 into a cache confinement site 420 (for example, while other quantum objects are transported to storage area 430), the quantum object disposed at the cache confinement site 420 may be reinserted into the bulk flow of quantum objects along the data bus confinement corridor 410 at an relative quantum location that is advantageous for a forthcoming operation, for example, adjacent to another quantum object that the quantum object is to be gated with during the forthcoming operation.

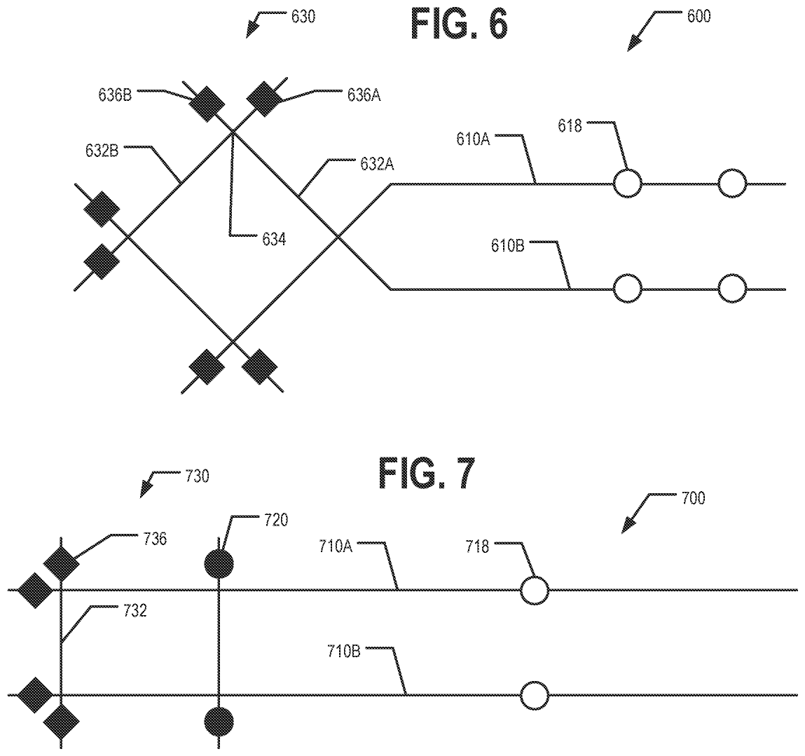

For example, a cache transport time t_{c} is the time required to transport a quantum object from a cache confinement site 420 to a quantum operation location 418 (or vice versa). A storage transport time tₛ is the time required to transport a quantum object from a storage area 430 to a quantum operation location 418 (or vice versa). In various embodiments, the storage transport time tₛ is an average time required to transport a quantum object from a storage area 430 (which may include a storage bus confinement corridor 432, rather than being a single site and/or there may be multiple storage areas 430A, 430B, 430C) to a quantum operation location 418. In various embodiments, the cache transport time is at most (e.g., less than or equal to) a defined fraction x of the storage transport time (e.g., t_{c}≤xtₛ, where 0<x<1). In various embodiments, the defined fraction x is 0.9, 0.8, 0.75, 0.7, 0.6, 0.5, 0.4, 0.3, 0.25, 0.2, 0.1 and/or the like. Particularly, the defined fraction x is less than one. FIG. 5 illustrates at least a portion of another example confinement apparatus 500. The confinement apparatus 500 comprises first and second data bus confinement corridors 510A, 510B. Each of the first and second data bus confinement corridors 510A, 510B extend between a first storage area 530A to a second storage area 530B. In the illustrated embodiment, the first and second storage areas 530A, 530B each comprise a grid of storage confinement corridors 532.

The first and second data bus confinement corridors 510A, 510B are coupled to the first and second storage areas 530A, 530B such that quantum objects may be transported between the first data bus confinement corridor 510A and the second data bus confinement corridor via the first and/or second storage area 530A, 530B.

The confinement apparatus further comprises a plurality of quantum operation locations 518 (e.g., 518A-518N represented by the open circles) coupled to and/or accessible to quantum objects via a respective one of the first or second data bus confinement corridor 510A. 510B. In the illustrated embodiment, the plurality of quantum operation locations 518 each disposed along a respective one of the first and second data bus confinement corridors 510A, 510B. Each of the quantum operation locations 518 are configured to have one or more quantum operations (e.g., one or more single qubit gates, two-qubit gates, reading/detection operation, qubit initialization operation, cooling operation, and/or the like) performed on one or more quantum objects located thereat (e.g., via application of one or more manipulation signals, magnetic field gradients, and/or the like).

The confinement apparatus 500 further comprises a plurality of cache confinement sites 520 (e.g., 520A-520M represented by the filled circles). In various embodiments, the cache confinement sites 520 are coupled to the data bus confinement corridors 510 via junctions. For example, the cache confinement sites 520 are “dead end” trapping regions coupled to the respective data bus confinement corridor 510 via a junction. In the illustrated embodiment, the cache confinement sites 520 are disposed between a data bus confinement corridor 510 and a respective storage area 530A, 530B.

Each of the cache confinement sites 520 are disposed near at least one of the quantum operation locations 518. For example, the distance between a cache confinement site 520 and at least one quantum operation location 518 is less than the distance between at least one storage area 530 and at least one quantum operation location 518. For example, the storage areas 530 and the cache confinement sites 520 form a memory hierarchy where the quantum objects disposed at the cache confinement sites 520 are retrievable (e.g., can be transported to a quantum operation location 518) on a faster time scale than the quantum objects disposed in the storage areas 530. Similarly, quantum objects can be transported from a quantum operation location 518 to a cache confinement site 520 on a faster time scale than transporting the quantum object between the quantum operation location 518 and a storage area 530.

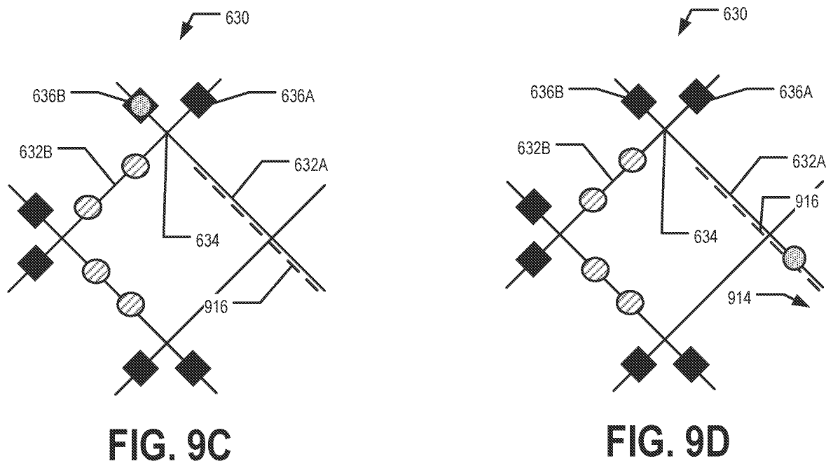

Moreover, the storage area 530, which may be larger than illustrated in various embodiments, may be configured to perform parallel transport operations through the use of broadcast voltage signals (e.g., applied to at least some of the control electrodes of the storage confinement corridors 532). Transport within, into, and/or out of the cache confinement sites 520 is controlled independently of the transport operations performed in the storage area 530. Thus, the quantum objects disposed within the cache confinement sites are exempted from the larger quantum object flow of the bulk storage areas 530. This enables the quantum objects disposed within the cache confinement sites to maintain and/or retain their proximity (and therefore short transit time) to the operation locations 518, as discussed in more detail herein with respect to FIG. 9, for example.

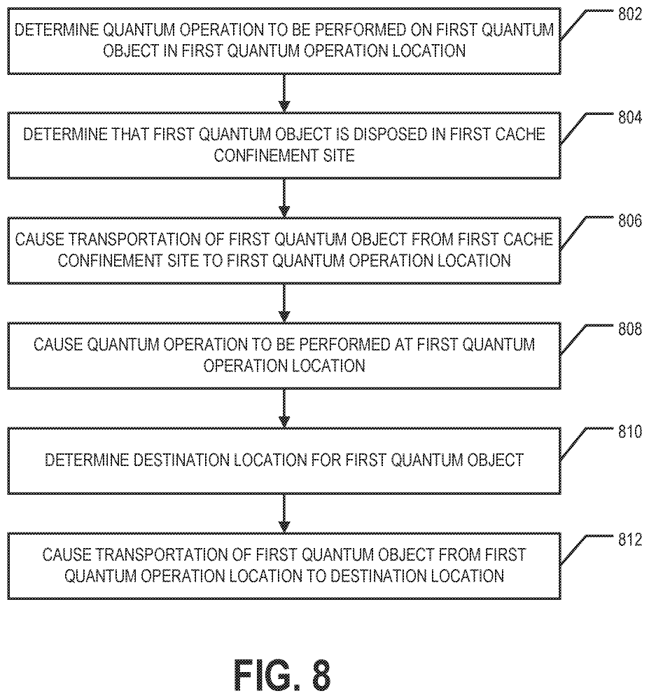

For example, a cache transport time t_{c} is the time required to transport a quantum object from a cache confinement site 520 to a quantum operation location 518 (or vice versa). A storage transport time tₛ is the time required to transport a quantum object from a storage area 530 to a quantum operation location 518 (or vice versa). In various embodiments, the storage transport time tₛ is an average time required to transport a quantum object from a storage area 530 to a quantum operation location 518. In various embodiments, the cache transport time is at most (e.g., less than or equal to) a defined fraction x of the storage transport time (e.g., t_{c}≤xtₛ, where 0<x<1). In various embodiments, the fraction x is 0.9, 0.8, 0.75, 0.7, 0.6, 0.5, 0.4, 0.3, 0.25, 0.2, 0.1 and/or the like. Particularly, the fraction x is less than one. FIG. 6 illustrates at least a portion of another example confinement apparatus 600. The confinement apparatus 600 comprises first and second data bus confinement corridors 610A, 610B. Each of the first and second data bus confinement corridors 510A, 510B extend away from a cyclic storage area 630.

The cyclic storage area 630 comprises a plurality of storage bus confinement corridors 632 (e.g., 632A, 632B) coupled to one another via respective junctions 634. The storage bus confinement corridors 632 are coupled to one another such that quantum objects can be cyclically transported around the cyclic storage area 630. In the illustrated embodiment, the storage bus confinement corridors 632 are further coupled to sorting confinement sites 636 (e.g., 636A, 636B, shown as the filled diamonds) via the junctions 634. In various embodiments, when quantum objects are being cyclically transported about the cyclic storage area 630, one or more quantum objects may be transported into a sorting confinement sites 636. For example, the sorting confinement sites 636 may be used to efficiently sort quantum objects disposed within the cyclic storage area 630, an example of which is illustrated in FIGS. 9A-9D.

The first and second data bus confinement corridors 610A, 610B are coupled to the cyclic storage area 630 such that quantum objects may be transported between the first data bus confinement corridor 610A and the cyclic storage area 630 (or vice versa) and between the second data bus confinement corridor 610B and the cyclic storage area 630 (or vice versa). In an example embodiment, quantum objects may be transported directly from the first data bus confinement corridor 610A to the second data bus confinement corridor 610B (or vice versa).

The confinement apparatus further comprises a plurality of quantum operation locations 618 (represented by the open circles) coupled to and/or accessible to quantum objects via a respective one of the first or second data bus confinement corridor 610A, 610B. In the illustrated embodiment, the plurality of quantum operation locations 618 each disposed along a respective one of the first and second data bus confinement corridors 610A, 610B. Each of the quantum operation locations 618 are configured to have one or more quantum operations (e.g., one or more single qubit gates, two-qubit gates, reading/detection operation, qubit initialization operation, cooling operation, and/or the like) performed on one or more quantum objects located thereat (e.g., via application of one or more manipulation signals, magnetic field gradients, and/or the like).

While not shown in FIG. 6, in an example embodiment, the confinement apparatus 600 further comprises a plurality of cache confinement sites. For example, the cache confinement sites may be coupled to the data bus confinement corridors 610 via junctions. For example, the cache confinement sites may be “dead end” trapping regions coupled to the respective data bus confinement corridor 610 via a junction.

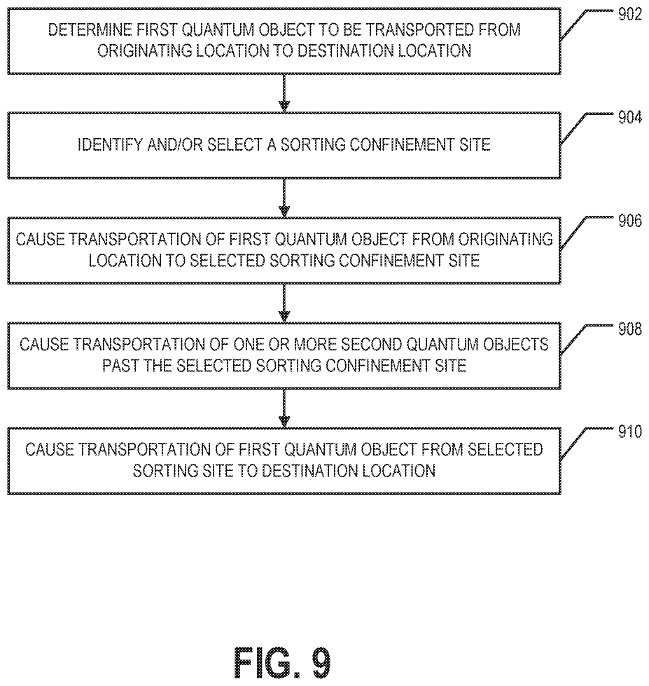

FIG. 7 illustrates at least a portion of another example confinement apparatus 700. The confinement apparatus 700 comprises first and second data bus confinement corridors 710A, 710B. Each of the first and second data bus confinement corridors 710A, 710B extend away from a storage area 730.

The storage area 730 comprises a plurality of storage bus confinement corridors 732 coupled to one another via respective junctions. The storage bus confinement corridors 732 are coupled to one another such that quantum objects can be transported between various ones of the storage bus confinement corridors. In various embodiments, at least one storage bus confinement corridor 732 is coupled to a sorting confinement site 736 (represented as the filled diamonds) via at least one junction. In various embodiments, the sorting confinement site 736 may be used to simplify a sorting operation being performed within the storage area 730. For example, the sorting confinement sites 736 may be used to efficiently sort quantum objects disposed within the storage area 730.

The first and second data bus confinement corridors 710A, 710B are coupled to the storage area 730 such that quantum objects may be transported between the first data bus confinement corridor 710A and the storage area 730 (or vice versa) and between the second data bus confinement corridor 710B and the storage area 730 (or vice versa). In an example embodiment, quantum objects may be transported directly from the first data bus confinement corridor 710A to the second data bus confinement corridor 710B (or vice versa).

The confinement apparatus further comprises a plurality of quantum operation locations 718 (represented by the open circles) coupled to and/or accessible to quantum objects via a respective one of the first or second data bus confinement corridor 710A, 710B. In the illustrated embodiment, the plurality of quantum operation locations 718 each disposed along a respective one of the first and second data bus confinement corridors 710A, 710B. Each of the quantum operation locations 718 are configured to have one or more quantum operations (e.g., one or more single qubit gates, two-qubit gates, reading/detection operation, qubit initialization operation, cooling operation, and/or the like) performed on one or more quantum objects located thereat (e.g., via application of one or more manipulation signals, magnetic field gradients, and/or the like).

The confinement apparatus 700 further comprises a plurality of cache confinement sites 720 (represented by the filled circles). In various embodiments, the cache confinement sites 720 are coupled to the data bus confinement corridors 710 via junctions. For example, the cache confinement sites 720 are “dead end” trapping regions coupled to the respective data bus confinement corridor 710 via a junction. In the illustrated embodiment, the cache confinement sites 720 are disposed between a data bus confinement corridor 510 and the storage area 730.

Each of the cache confinement sites 720 are disposed near at least one of the quantum operation locations 718 (or closer to the at least one of the quantum operation locations 718 than the storage area 730 is). For example, the distance between a cache confinement site 720 and at least one quantum operation location 718 is less than the distance between at least one storage area 730 and at least one quantum operation location 718.

For example, the storage area 730 and the cache confinement sites 720 form a memory hierarchy where the quantum objects disposed at the cache confinement sites 720 are retrievable (e.g., can be transported to a quantum operation location 718) on a faster time scale than the quantum objects disposed in the storage areas 730. Similarly, quantum objects can be transported from a quantum operation location 718 to a cache confinement site 720 on a faster time scale than transporting the quantum object to from the quantum operation location 718 to a storage area 730.

For example, a cache transport time t_{c} is the time required to transport a quantum object from a cache confinement site 720 to a quantum operation location 718 (or vice versa). A storage transport time tₛ is the time required to transport a quantum object from the storage area 730 to a quantum operation location 718 (or vice versa). In various embodiments, the storage transport time tₛ is an average time required to transport a quantum object from the storage area 730 to a quantum operation location 718. In various embodiments, the cache transport time is at most (e.g., less than or equal to) a defined fraction x of the storage transport time (e.g., t_{c}≤xtₛ, where 0<x<1). In various embodiments, the defined fraction x is 0.9, 0.8, 0.75, 0.7, 0.6, 0.5, 0.4, 0.3, 0.25, 0.2, 0.1 and/or the like. Particularly, the defined fraction x is less than one. While the illustrated embodiments of the confinement apparatus 300, 400, 500, 600, 700 include two data bus confinement corridors, various embodiments, may include one data bus confinement corridor and/or three or more data bus confinement corridors. For example, the number and layout of the data bus confinement corridors, placement of the quantum operation locations, placement of the cache confinement sites, and/or the like of the confinement apparatus may be configured based at least in part on the type of experiments and/or computations to be performed using the confinement apparatus, number of qubits to be available for the performance of the experiments and/or computations, and/or the like.

### Example Operation of a System Comprising a Confinement Apparatus

In various embodiments, confinement apparatuses comprising data bus confinement corridors that are coupled to and/or provide access to quantum operation locations are used to confine one or more quantum objects and perform quantum operations on the quantum objects. In various embodiments, the confinement apparatus comprises one or more cache confinement sites and/or sorting confinement sites that are used to simplify transportation operations and/or store particular quantum objects closer to the quantum operation locations (e.g., compared to the storage area(s) of the confinement apparatus).

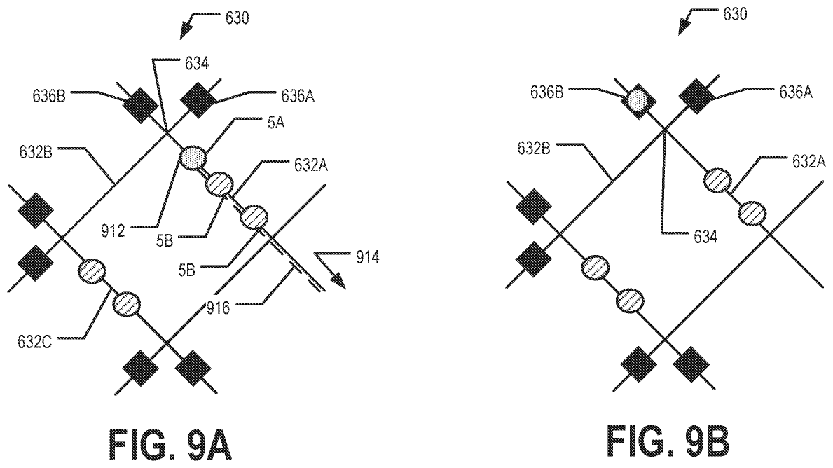

FIG. 8 provides a flowchart illustrating various processes, procedures, and/or the like for performing a quantum operation using a quantum object that is disposed at a cache confinement site prior to performance of the quantum operation and then returned to the same or a different cache confinement site after performance of the quantum operation. As should be understood, in various embodiments, a quantum operation may be performed using a quantum object that is disposed at a cache confinement site prior to performance of the quantum operation but that is not returned to a cache confinement site after performance of the quantum operation or using a quantum object that is not disposed at a cache confinement site prior to the performance of the quantum operation but that is moved to a cache confinement site after performance of the quantum operation. In various embodiments, the processes, procedures, and/or the like illustrated in FIG. 8 are performed by a controller of the system comprising the confinement apparatus, such as controller 30 of FIG. 10, for example.

Starting at step 802, the controller 30 determines that a quantum operation is to be performed on a first quantum object at a first quantum operation location. In various embodiments, the controller 30 is configured to execute (e.g., via a semiconductor-based processing device thereof) one or more queues of executable instructions. In an example embodiment, the controller 30 identifies and/or determines that the quantum operation is to be performed on the first quantum object by monitoring at least one of the one or more queues and/or responsive to scheduling the performance of the quantum operation. While the first quantum object is referred to in the singular herein, the first quantum object may be a plurality of quantum objects (e.g., two or more quantum objects).

For example, the controller 30 may be configured to execute a quantum program and/or circuit that indicates which quantum operations are to be performed on which quantum objects in which order. The controller 30 may process the quantum program and/or circuit and, based thereon, schedule the performance of one or more sequences of executable instructions to form at least a portion of the one or more queues. For example, a first queue may be executable by a driver controller element configured to control operation of a first manipulation source 64A. A second queue, for example comprises executable instructions configured to be executed by a driver controller element configured to control operation of one or more of the voltage sources 50. Thus, by monitoring the one or more queues, monitoring the quantum program and/or circuit, and/or responsive to scheduling the performance (e.g., scheduling executable instructions to control the operation of one or more manipulation sources 64 and/or one or more voltage sources 50 to cause the performance) of the quantum operation to one or more queues, the controller 30 determines that the quantum operation is to be performed on the first quantum object at the first quantum operation location.

In an example embodiment, the quantum program and/or circuit, and/or the executable instructions comprise a qubit identifier configured to identity the first quantum object such that controller 30 determines that the quantum operation is to be performed on the first quantum object. In various scenarios, the quantum operation may be performed on multiple quantum objects at respective quantum operation locations and/or at the first quantum operation location. For example, the quantum operation may be a two-qubit gate configured to entangle the first quantum object with another quantum object. In another example, the quantum operation may be a single qubit gate, qubit initialization operation, qubit reading/detecting operation, and/or the like performed in parallel at multiple quantum operation locations.

At step 804, the controller 30 determines that the first quantum object is currently disposed at the first cache confinement site. For example, the controller 30 comprises a classical (e.g., semiconductor-based) memory that stores a classical qubit record for each qubit of the quantum program and/or circuit. The classical qubit record indicates an originating location of the respective quantum object, in various embodiments. The classical qubit record may include various other information regarding the respective quantum object, in various embodiments (e.g., phase accumulation, and/or the like).

The controller 30 identifies the classical qubit record corresponding to the first quantum object (e.g., the classical qubit record indexed by the qubit identifier configure to identify the first quantum object) and extracts, reads, access, and/or the like the originating location of the first quantum object therefrom. In the example provided by FIG. 8, the first quantum object is disposed at the first cache confinement site.

At step 806, the controller 30 causes transportation of the first quantum object from the first cache confinement site to the first quantum operation location. For example, the controller 30 may schedule one or more executable instructions to be executed by controller driver elements configured to control operation of the voltage sources 50 to cause voltage signals to be applied to the control electrodes 216 such that the electric potential of the confinement apparatus causes the first quantum object to be transported from the first cache confinement site to the first quantum operation location.

As should be understood, the distance between the first cache confinement site and the first quantum operation location is less than the distance between a storage area of the confinement apparatus and the first quantum operation location. Thus, the transport time for transporting the first quantum object from the first cache confinement site to the first quantum operation location is smaller than the transport time would be to transport the first quantum object to the first quantum operation location from the storage area.

At step 808, the controller 30 causes the quantum operation to be performed on the first quantum object at the first quantum operation location. For example, the controller 30 may control one or more manipulation sources 64 to cause one or more manipulation signals to be incident on the first quantum object (and possibly another quantum object) disposed at the first quantum operation location to cause the quantum operation to be performed on the first quantum object. In another example, the controller 30 controls one or more magnetic field sources 70 to cause the first quantum object (and possibly another quantum object) disposed at the first quantum operation location to experience a magnetic field gradient to cause the quantum operation to be performed on the first quantum object.

At step 810, the controller 30 determines a destination location for the first quantum object. In some instances, the controller 30 determines that the first quantum object is to be transported from the first quantum operation location to the first cache confinement site. For example, the controller 30 may determine whether, after performance of the quantum operation at the first quantum operation location, to (a) maintain the first quantum object at the first quantum operation location, (b) transport the first quantum object to a second/different quantum operation location, (c) transport the first quantum object to a cache confinement site (selected by the controller 30), or (d) transport the first quantum object to a storage area. For example, the destination location is selected from the group comprising (a) the first quantum operation location, (b) a second/different quantum operation location, (c) an identified and/or selected cache confinement site, and (d) a storage area, in an example embodiment.

Responsive to the controller 30 determining (e.g., based on the quantum program and/or circuit) that the next quantum operation to be performed at the first quantum operation location is to be performed on the first quantum object (e.g., a single or two-qubit quantum logic gate to be performed on the first quantum object, a re-initializing of the first quantum object, a reading/detecting of the quantum state of the first quantum object), the controller 30 determines that the first quantum object is to be maintained at the first quantum operation location.

Responsive to the controller 30 determining (e.g., based on the quantum program and/or circuit) that the next quantum operation to be performed at a second/different quantum operation location is to be performed on the first quantum object (e.g., a single or two-qubit quantum logic gate to be performed on the first quantum object, a re-initializing of the first quantum object, a reading/detecting of the quantum state of the first quantum object), the controller 30 determines that the first quantum object is to be transported to the second/different quantum operation location.

Responsive to the controller 30 determining (e.g., based on the quantum program and/or circuit) that a quantum operation is to be performed on the first quantum object within a specified time, within a specified number of quantum operations, and/or the like, the controller 30 determines that the first quantum object is to be transported to a cache confinement site. In an example embodiment, the controller determines that the first quantum object is to be transported to a cache confinement site responsive to determining that the first quantum object has at least a specified rank, where the specified rank indicates an order in which the quantum objects will next be needed in the performance of the quantum program and/or cycle. For example, if the next ten quantum operations to be performed are each to be performed on a second quantum object and a third quantum object and the eleventh quantum operation is be performed on the first quantum object, the first quantum object is associated with a rank indicating that the first quantum object will be used in the performance of the quantum program and/or circuit prior to the use of quantum objects that will not be used until the twelfth quantum operation from now or later.

In various embodiments, determining whether the first quantum object is to be transported to a cache confinement site comprises determining, by the controller 30 and based on information corresponding to cache confinement site usage stored in the classical memory of the controller 30, whether a cache confinement site located near the first quantum operation location or the second quantum operation location where the first quantum object is next to be used is available (e.g., unoccupied by a quantum object, occupied below a maximum population of quantum objects, and/or the like). For example, if the first quantum operation location is quantum operation location 318A of confinement apparatus 300 and the second quantum operation location where the first quantum object is be used is also accessible via the first data bus confinement corridor 310A, the controller 30 would determine whether any of cache confinement sites 320 are available. In an example embodiment, the controller 30 only determines whether any of the cache confinement sites 320 accessible via the same data bus confinement corridor as the first quantum operation location 318A and/or the second quantum operation location are available. For example, in this example, the controller may only determine whether any of cache confinement sites 320A-320H (accessible via the first data bus confinement corridor 310A) are available and may not check the availability of cache confinement sites 320I, 320J (accessible via the second data bus confinement corridor 310B).

Based at least in part on the determined cache confinement site availability, the first quantum operation location, and/or the second quantum operation location, the controller 30 identifies and/or selects a cache confinement site to which the first quantum object is to be transported.

Responsive to the controller 30 determining (e.g., based on the quantum program and/or circuit) that a quantum operation is not to be performed on the first quantum object within a specified time, within a specified number of quantum operations, and/or the like, the controller 30 determines that the first quantum object is to be transported to a storage area. In an example embodiment, the controller determines that the first quantum object is to be transported to a storage area responsive to determining that the first quantum object does not have at least a specified rank, where the specified rank indicates an order in which the quantum objects will next be needed in the performance of the quantum program and/or cycle. In an example embodiment, the controller 30 determines that the first quantum object is to be transported to a storage area responsive to determining that no appropriate cache confinement sites are available (e.g., no cache confinement sites accessible via the same data bus confinement corridor as the first quantum operation location and/or the next quantum operation location are available).

At step 812, the controller 30 causes the first quantum object to be transported to the destination location for the first quantum object. For example, in instances where the controller 30 determined that the first quantum object is to be transported to an identified and/or selected cache confinement site, the controller 30 causes the first quantum object to be transported to the identified and/or selected cache confinement. In an instance where the controller 30 determined that the first quantum object is to be transported to a second quantum operation location or transported to a storage area, the controller 30 causes the first quantum object to be transported to the respective one of the second quantum operation location or the storage area. In an instance where the controller 30 determined the first quantum object is to be maintained at the first quantum operation location, the controller 30 causes the first quantum object to stay at the first quantum operation location.

For example, the controller 30 may schedule one or more executable instructions to be executed by controller driver elements configured to control operation of the voltage sources 50 to cause voltage signals to be applied to the control electrodes 216 such that the electric potential of the confinement apparatus causes the first quantum object to be transported to the destination location determined for the first quantum object. For example, the voltage signals applied to the control electrodes 216 may cause the first quantum object to be maintained at the first quantum operation location or transported to a respective one of the second quantum operation location, identified and/or selected cache confinement site, storage area.

For example, in various embodiments, a quantum object is stored and/or maintained at a cache confinement site between quantum operations performed on the quantum object. In various embodiments, a quantum object is stored and/or maintained at a cache confinement site between successive quantum operations performed on the quantum object when the time between the successive quantum operations performed on the quantum object satisfies particular criteria, when the locations at which the successive quantum operations performed on the quantum object satisfy particular criteria (e.g., the first and second quantum operation locations are accessible via the same data bus confinement corridor, and/or the like), and/or when other specified criteria are satisfied. As used herein the term “successive quantum operations performed on the quantum object” refers to successive quantum operations from the perspective of the quantum object and there may or may not be other quantum operations performed on other quantum objects, according to the quantum program and/or circuit, between the successive quantum operations performed on the quantum object.

As should be understood, the distance between the identified and/or selected cache confinement site and the first quantum operation location and/or the second quantum operation location is less than the distance between a storage area of the confinement apparatus and the first quantum operation location and/or second quantum operation location. Thus, the transport time for transporting the first quantum object from the first quantum operation location to the identified and/or selected cache confinement site and/or for transporting the first quantum object from the identified and/or selected cache confinement site to the second quantum operation location is smaller than the transport time would be to transport the first quantum object to the storage area from the first quantum operation location and/or from the storage area to the second quantum operation location.

FIG. 9 provides a flowchart that illustrates various process, procedures, and/or the like performed by the controller 30 to perform a sorting operation using a sorting confinement site. In various embodiments, the sorting confinement site(s) of a confinement apparatus comprise one or more dedicated sorting confinement sites disposed in a storage area (e.g., sorting confinement sites 636, 732 of confinement apparatuses 600, 700, respectively). In various embodiments, the cache confinement sites of a confinement apparatus are also used as sorting confinement sites. For example, when a cache confinement site is unoccupied by a quantum object, occupied below a maximum population of quantum objects, and/or the like, the cache confinement site may be used, by the controller 30, as a sorting confinement site, in various embodiments.

Starting at step 902, the controller 30 determines that a first quantum object is to be transported from an originating location to a destination location. For example, the controller 30 processes a quantum program and/or circuit and/or monitors one or more queues of executable instructions and, based thereon determines that the first quantum object is to be transported from an originating location to a destination location. For example, the quantum program and/or circuit may indicate the destination location for the first quantum object and a quantum object record stored in the classical memory of the controller 30 and indexed by a quantum object identifier configured to uniquely identify the first quantum object may indicate the originating location of the first quantum object. In various embodiments, the quantum program and/or circuit indicates the time (e.g., clock time or a particular clock cycle of the quantum processor 115) at which the transportation of the quantum object from the originating location to the destination location is to be initiated and/or completed.

In various embodiments, the controller 30 also determines a transportation path from the originating location to the destination location. In an example embodiment, the transportation path is the shortest path between the originating location and the destination location along trapping regions of the confinement apparatus.

At step 904, the controller 30 identifies one or more available sorting confinement sites that are accessible via the transportation path from the originating location to the destination location or from a confinement corridor (e.g., storage confinement corridor and/or data bus confinement corridor) that overlaps, at least in part, with at least a portion of the transportation path from the originating location to the destination location. For example, the transportation path from the originating location to the destination location may include traveling along a particular confinement corridor (e.g., storage confinement corridor and/or data bus confinement corridor) in a first direction from the originating location. The identified one or more available sorting confinement sites may include one or more confinement sites accessible via the particular confinement corridor in the first direction or in an opposite, second direction from the originating location of the first quantum object.

The controller 30 selects a sorting confinement site from the identified one or more available sorting confinement sites based at least in part on one or more of respective location of the identified one or more available sorting confinement sites, the number and/or location of other quantum objects along the transportation path and/or on one or more confinement corridors that overlap, at least in part, with at least a portion of the transportation path and, possibly other selection criteria.

At step 906, the controller 30 causes the first quantum object to be transported from the originating location to the selected sorting confinement site. For example, the controller 30 may schedule one or more executable instructions to be executed by controller driver elements configured to control operation of the voltage sources 50 to cause voltage signals to be applied to the control electrodes 216 such that the electric potential of the confinement apparatus causes the first quantum object to be transported from the originating location to the selected sorting confinement site.

For example, FIG. 9A shows a plurality of quantum objects 5 (e.g., 5A, 5B, shown as the pattern-filled circles) disposed on a first storage confinement corridor 532A and a third storage confinement corridor 532C, prior to the performance of step 906. A first quantum object 5A and two second quantum objects 5B are disposed along the first storage confinement corridor 532A. Some additional quantum objects are disposed along the third storage confinement corridor 532C, in the illustrated example.

For example, the first quantum object 5A is disposed at the originating location 912 along the first storage confinement corridor 932A. The destination location 914 is not shown, but the direction to which is indicated by arrow labeled 914 such that the dashed line represents a portion of the transportation path 916. The dashed line is shown separated from the first storage confinement corridor 632A to make it visible in the drawing.

FIG. 9B shows the plurality of quantum objects 5 after performance of step 906. For example, the first quantum object 5A has been transported to the selected sorting confinement site 636B from the originating location 912.

Continuing with FIG. 9, at step 908, the controller 30 causes one or more second quantum objects 5B to be transported past the selected sorting confinement site. For example, the controller 30 may schedule one or more executable instructions to be executed by controller driver elements configured to control operation of the voltage sources 50 to cause voltage signals to be applied to the control electrodes 216 such that the electric potential of the confinement apparatus causes one or more second quantum objects 5B to be transported past the selected sorting confinement site 636B. For example, the second quantum objects 5B comprise quantum objects that are disposed along the transportation path 916 prior to the performance of step 908.

For example, FIG. 9C shows the plurality of quantum objects 5 after performance of step 908. The second quantum objects 5B that were previously disposed along the transportation path 916 have been transported from the first storage confinement corridor 632A, past the selected sorting confinement site 636B, to the second storage confinement corridor 632B. thus, as a result of the performance of step 908, the second quantum objects 5B are no longer disposed along the transportation path 916 (and are not disposed between the selected sorting confinement site 636B and the transportation path 916).

In various embodiments, transporting the one or more second quantum objects past the selected sorting confinement site comprises transporting the one or more second quantum objects from a first side of the sorting confinement site to a second side of the sorting confinement site. For example, in FIG. 9B, the one or more second quantum objects are disposed to the right (a first side) of the selected sorting confinement site 636B and, in FIG. 9C, the one or more second quantum objects have been transported past the selected sorting confinement site 636B and a disposed on the left (a second side) of the selected sorting confinement site 636B.

Continuing with FIG. 9, at step 910, the controller 30 causes the first quantum object 5A to be transported from the selected sorting confinement site 636B to the destination location 914. For example, the controller 30 may schedule one or more executable instructions to be executed by controller driver elements configured to control operation of the voltage sources 50 to cause voltage signals to be applied to the control electrodes 216 such that the electric potential of the confinement apparatus causes the first quantum object 5A to be transported from the selected sorting confinement site 636B to the destination location 914. In an example embodiment, the first quantum object 5A is transported from the selected sorting confinement site 636B to the destination location 914 at least partially along the transportation path 916.

For example, FIG. 9D illustrates the performance of step 910, where the first quantum object 5A is being transported from the selected sorting confinement site 636B, along the transportation path 916, and toward the destination location 914. In various embodiments, the destination location is a cache confinement site, a quantum operation location, a location along a data bus confinement corridor, or other location defined at least in part by the confinement apparatus.

Through the use of the sorting confinement site to perform the transportation operation, the performance of re-ordering or swapping operations between the first quantum object 5A and each second quantum object 5B is prevented. During re-ordering or swapping operations, the quantum objects involved in the re-ordering or swapping operation are moved off of the radio frequency (RF) null of the confinement corridor along which the quantum objects are located. This results in increased heating of the quantum objects involved in the re-ordering or swapping operation, which may reduce the fidelity with which the quantum information stored by the quantum states of the quantum objects is maintained. Additionally, performing re-ordering or swapping operations takes more time than merely transporting the quantum objects along the respective confinement corridors. Thus, the use of the sorting confinement site to perform the transportation operation reduces the heating of the quantum objects, increases the fidelity with which quantum information stored by the quantum states of the quantum objects is maintained, and reduces the amount of time required to perform the routing and sorting operations.

### Technical Advantages

In conventional quantum object confinement apparatuses comprising data bus confinement corridors or similar one-dimensional trapping regions used to transport quantum objects in and/or out of quantum operation locations accessible via a respective one-dimensional trapping region, transporting a quantum object from a storage area to a quantum operation location can take a significant amount of time. For example, it may take significantly more time to perform transportation operations to transport the quantum objects throughout the performance of a quantum program and/or circuit than to perform the quantum operations (e.g., single qubit and/or two-qubit quantum logic gates, and/or the like). For example, a non-negligible fraction of the coherence time of the quantum state of the quantum objects may be used to transport the quantum object between locations of a confinement apparatus. Transportation of the quantum object may also cause undesired heating of the quantum object.

Additionally, if a plurality of quantum objects is confined by the confinement apparatus, rearranging and/or swapping positions of the quantum objects within the one-dimensional confinement regions may require a significant number of swapping and/or re-ordering operations to properly sort the quantum objects. These swapping and/or re-ordering operations also take time and may lead to additional undesired heating of the quantum objects. Thus, technical problems exist regarding the efficient routing and sorting of quantum objects confined by a quantum object confinement apparatus.

Embodiments of the present disclosure provide technical solutions to these technical problems. Various embodiments provide confinement apparatuses and/or systems comprising confinement apparatuses that comprise one or more data bus confinement corridors and one or more cache confinement sites and/or sorting confinement sites. Each of the one or more data bus confinement corridors comprises and/or enables one or more quantum objects to be transported into and/or out of one or more quantum operation locations. Each of the cache confinement sites is coupled to a respective data bus confinement corridor such that quantum objects may be transported from the respective data bus confinement corridor into the cache confinement site and/or from the cache confinement site into the data bus confinement corridor. The cache confinement sites enable quantum objects to be stored near the quantum operation locations such that a quantum object may be transported between a quantum operation location and a cache confinement site (or vice versa) faster and with reduced heating (compared to a longer distance transportation operation). Additionally, in various embodiments, the cache confinement sites are configured for high fidelity data storage (e.g., are configured to reduce the ability of stray fields to interact with and/or perturb the quantum states of quantum objects disposed at the cache confinement sites). Various embodiments therefore provide an improvement to the field of confinement apparatuses and methods relating to and/or including transportation quantum objects confined by confinement apparatuses.

### Exemplary Controller

Various embodiments provide systems comprising confinement apparatuses 200, 300, 400, 500, 600, 700. In an example embodiment, the system is a quantum charge-coupled device (QCCD-based) quantum computer 110 or other quantum computer. In various embodiments, the system (e.g., quantum computer 110) further comprises a controller 30 configured to control various elements of the system. For example, the controller 30 may be configured to control the voltage sources 50, a cryogenic system and/or vacuum system for controlling the temperature and pressure within the cryogenic and/or vacuum chamber 40, manipulation sources 64 (e.g., 64A, 64B, 64C), magnetic field sources 70 (e.g., 70A, 70B), and/or other systems controlling the environmental conditions (e.g., temperature, humidity, pressure, magnetic field gradient, and/or the like) within the cryogenic and/or vacuum chamber 40, configured to manipulate and/or cause a controlled evolution of quantum states of one or more quantum objects confined by the confinement apparatus, and/or read and/or detect a quantum state of one or more quantum objects confined by the confinement apparatus.

As shown in FIG. 10, in various embodiments, the controller 30 may comprise various controller elements including one or more processing devices 1005, memory 1010, driver controller elements 1015, a communication interface 1020, analog-digital converter elements 1025, and/or the like. For example, the one or more processing devices 1005 may comprise one or more processing elements such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. The term circuitry may refer to an entirely hardware embodiment or a combination of hardware and computer program products. In an example embodiment, the one or more processing devices 1005 of the controller 30 comprises a clock and/or is in communication with a clock. In various embodiments, this clock defines the clock cycles of the system.

For example, the memory 1010 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 1010 may store qubit records corresponding the qubits of quantum computer (e.g., in a qubit record data store, qubit record database, qubit record table, and/or the like), a calibration table, an executable queue, computer program code (e.g., in a one or more computer languages, specialized controller language(s), and/or the like), and/or the like. In an example embodiment, execution of at least a portion of the computer program code stored in the memory 1010 (e.g., by a processing device 1005) causes the controller 30 to perform one or more steps, operations, processes, procedures and/or the like described herein for controlling one or more components of the quantum computer 110 (e.g., voltage sources 50, manipulation sources 64, magnetic field sources 70, and/or the like) to cause a controlled evolution of quantum states of one or more quantum objects, detect and/or read the quantum state of one or more quantum objects, and/or the like.

In various embodiments, the driver controller elements 1015 may include one or more drivers and/or controller elements each configured to control one or more drivers. In various embodiments, the driver controller elements 1015 may comprise drivers and/or driver controllers. For example, the driver controllers may be configured to cause one or more corresponding drivers to be operated in accordance with executable instructions, commands, and/or the like scheduled and executed by the controller 30 (e.g., by the processing device 1005). In various embodiments, the driver controller elements 1015 may enable the controller 30 to operate a manipulation source 64. In various embodiments, the drivers may be laser drivers; vacuum component drivers; drivers for controlling the flow of current and/or voltage applied to RF, control, and/or other electrodes (e.g., shim electrodes and/or the like) used for maintaining and/or controlling the confinement potential of the confinement apparatus (and/or other driver for providing driver action sequences and/or control signals to potential generating elements of the confinement apparatus); cryogenic and/or vacuum system component drivers; and/or the like. For example, the drivers may control and/or comprise control and/or RF voltage drivers and/or voltage sources that provide voltages and/or electrical signals to the control electrodes 216 and/or RF electrodes 212, 222. In various embodiments, the controller 30 comprises means for communicating and/or receiving signals from one or more detectors such as optical receiver components (e.g., cameras, MEMs cameras, CCD cameras, photodiodes, photomultiplier tubes, and/or the like) of the optics collection system 80. For example, the controller 30 may comprise one or more analog-digital converter elements 1025 configured to receive signals from one or more detectors, optical receiver components, calibration sensors, and/or the like.

In various embodiments, the controller 30 may comprise a communication interface 1020 for interfacing and/or communicating with one or more computing entities 10. For example, the controller 30 may comprise a communication interface 1020 for receiving executable instructions, command sets, and/or the like from the computing entity 10 and providing output received from the quantum processor 115 (e.g., via the optics collection system 80) and/or the result of a processing the output (received from the quantum processor 115) to the computing entity 10. In various embodiments, the computing entity 10 and the controller 30 may communicate via a direct wired and/or wireless connection and/or one or more wired and/or wireless networks 20.

### Exemplary Computing Entity

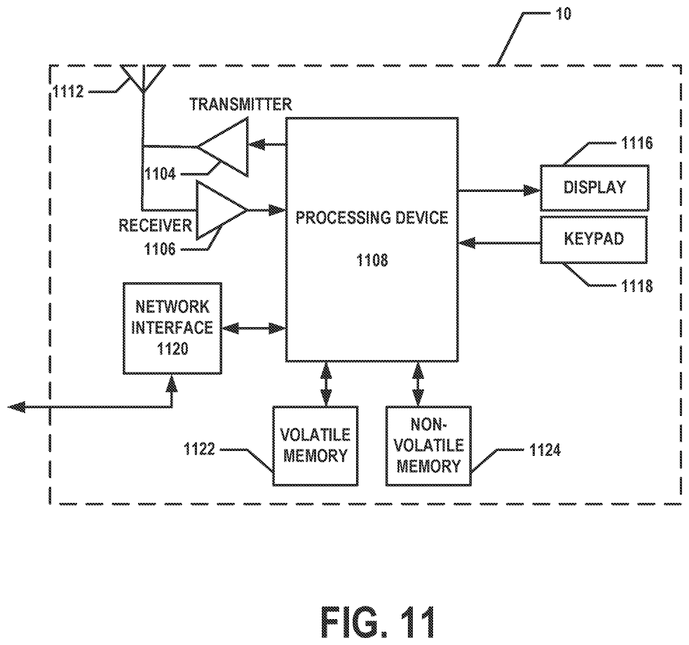

FIG. 11 provides an illustrative schematic representative of an example computing entity 10 that can be used in conjunction with embodiments of the present invention. In various embodiments, a computing entity 10 is configured to allow a user to provide input to the quantum computer 110 (e.g., via a user interface of the computing entity 10) and receive, display, analyze, and/or the like output from the quantum computer 110.

As shown in FIG. 11, a computing entity 10 can include an antenna 1112, a transmitter 1104 (e.g., radio), a receiver 1106 (e.g., radio), and a processing device 1108 that provides signals to and receives signals from the transmitter 1104 and receiver 1106, respectively.

The signals provided to and received from the transmitter 1104 and the receiver 1106, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system. In various embodiments, the computing entity 10 further comprises one or more network interfaces 1120 configured to communicate via one or more wired and/or wireless networks 20.

The computing entity 10 may also comprise a user interface device comprising one or more user input/output interfaces (e.g., a display 1116 and/or speaker/speaker driver coupled to a processing device 1108 and a touch screen, keyboard, mouse, and/or microphone coupled to a processing device 1108). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 1118 (hard or soft), a touch display, voice/speech or motion interfaces, scanners, readers, or other input device. In embodiments including a keypad 1118, the keypad 1118 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 1122 and/or non-volatile storage or memory 1124, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### CONCLUSION

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A quantum object confinement apparatus comprising:
one or more confinement corridors, each confinement corridor of the one or more confinement corridors defined at least in part by respective corridor sequences of control electrodes, the one or more confinement corridors are configured for transport of one or more quantum objects there along; and
one or more confinement sites, each confinement site of the one or more confinement sites defined at least in part by respective site sequences of control electrodes, each of the one or more confinement sites coupled to a respective confinement corridor such that one or more quantum objects may be transported from the respective confinement corridor to the confinement site and from the confinement site to the respective confinement corridor.

2. The quantum object confinement apparatus of claim 1, wherein the one or more confinement corridors comprise at least one of (a) one or more data bus confinement corridors configured to provide access to or at least partially define one or more quantum operation locations configured for performance of one or more quantum operations on one or more quantum objects located there at or (b) one or more storage bus confinement corridors configured for storage of quantum objects therein.

3. The quantum object confinement apparatus of claim 1, wherein the one or more confinement sites comprise at least one of (a) one or more cache confinement sites coupled to at least one data bus confinement corridor and disposed between a quantum operation confinement location accessible via the at least one data bus confinement corridor and a storage area of the quantum object confinement apparatus or (b) one or more sorting confinement sites.

4. The quantum object confinement apparatus of claim 1, wherein a confinement site of the one or more confinement sites is coupled to a respective confinement corridor of the one or more confinement corridors via a junction.

5. The quantum object confinement apparatus of claim 4, wherein the confinement site is a dead-end trapping region extending from the junction.

6. The quantum object confinement apparatus of claim 1, wherein a confinement corridor of the one or more confinement corridors is a data bus confinement corridor and a confinement site of the one or more confinement sites is a cache confinement site, a cache transport time is a time used to transport a quantum object between the cache confinement site and a quantum operation location accessible via the data bus confinement corridor, a storage transport time is a time used to transport the quantum object between a storage area of the quantum object confinement apparatus and the quantum operation location, and the cache transport time is less than or equal to a defined fraction of the storage transport time.

7. The quantum object confinement apparatus of claim 1, wherein a layout of the quantum confinement apparatus is configured to reduce perturbations experienced by a quantum object disposed at a confinement site of the one or more confinement sites.

8. The quantum object confinement apparatus of claim 1, wherein the site sequences of control electrodes are configured to generate an electric potential configured to receive one or more quantum objects therein via a single entrance/exit of the confinement site, maintain the one or more quantum objects at the confinement site, provide the one or more quantum objects through the single entrance/exit of the confinement site.

9. The quantum object confinement apparatus of claim 1, wherein a respective electric potential in a confinement corridor is configured to be controlled via application of one or more broadcast voltage signals to respective control electrodes of the respective corridor sequence of control electrodes and an electric potential of a respective cache confinement site of the one or more cache confinement sites is controlled independently of the one or more broad voltage signals and/or the respective electric potential in the confinement corridor.

10. The quantum object confinement apparatus of claim 1, wherein the one or more cache confinement sites are configured such that a quantum object disposed at a respective cache confinement site of the one or more cache confinement sites is exempted from a bulk quantum object sorting performed in a respective confinement corridor of the one or more confinement corridors.

11. The quantum object confinement apparatus of claim 1, wherein the quantum object confinement apparatus is configured to have a lower likelihood of stray fields at the one or more cache confinement sites compared to the one or more confinement corridors.

12. A method comprising:
causing a quantum object confinement apparatus to confine a plurality of quantum objects, wherein the quantum object confinement apparatus comprises:
one or more data bus confinement corridors, each data bus confinement corridor of the one or more data bus confinement corridors defined at least in part by respective corridor sequences of control electrodes, the one or more data bus confinement corridors configured for transport of one or more quantum objects there along, and a first data bus confinement corridor of the one or more data bus confinement corridors providing access to a first quantum operation location; and
one or more cache confinement sites, each cache confinement site of the one or more cache confinement sites defined at least in part by respective site sequences of control electrodes, a first cache confinement site of the one or more cache confinement sites coupled to the first data bus confinement corridor such that one or more quantum objects may be transported from the first data bus confinement corridor to the first confinement site and from the first cache confinement site to the first data bus confinement corridor; and
wherein the one or more quantum objects comprises a first quantum object; and
performing at least one of:
(a) causing the first quantum object to be transported from the first cache confinement region to the first quantum operation location via the first data bus confinement corridor, and
causing a quantum operation to be performed on at least the first quantum object at the first quantum operation location, or
(b) after performance of a quantum operation on the first quantum object at the first quantum operation location, causing the first quantum object to be transported to the first cache confinement region.

13. The method of claim 12, wherein the quantum object confinement apparatus further comprises at least one storage area accessible via the first data bus confinement corridor, a cache transport time is a time used to transport a quantum object between the first cache confinement site and the first quantum operation location, a storage transport time is a time used to transport the quantum object between the at least one storage area and the first quantum operation location, and the cache transport time is less than or equal to a defined fraction of the storage transport time.

14. The method of claim 12, wherein the quantum object confinement apparatus comprises one or more storage areas that are coupled to the first data bus confinement corridor and the first cache confinement site is disposed between the first quantum object location and at least one of the one or more storage areas.

15. The method of claim 12, wherein the first cache confinement site is coupled to the first data bus confinement corridor via a junction.

16. The method of claim 15, wherein the cache confinement site is a dead-end trapping region extending from the junction.

17. The method of claim 12, wherein a layout of the quantum confinement apparatus is configured to reduce perturbations experienced by the first quantum object while the first quantum object is disposed at the first cache confinement site.

18. A method for transporting a first quantum object from an originating location of a quantum object confinement apparatus to a destination location of the quantum object confinement apparatus, the method comprising:
causing transportation of the first quantum object confined by the quantum object confinement apparatus from the originating location of the quantum object confinement apparatus to a sorting confinement site of the quantum object confinement apparatus,
causing one or more second quantum objects disposed along a transportation path from the originating location to the destination location to be transported past the sorting confinement site; and
causing transportation of the first quantum object from the sorting confinement site to the destination location.

19. The method of claim 18, wherein the destination location is a quantum operation location or a cache confinement site.

20. The method of claim 18, wherein the sorting confinement site is selected from a plurality of sorting confinement sites of the quantum object confinement apparatus based at least in part on one or more of the location of the sorting confinement site compared to the transportation path, a number of one or more second quantum objects disposed along the transportation path, or respective locations of the one or more second quantum objects disposed along the transportation path.

21. The method of claim 18, wherein the sorting confinement site is coupled to at least one of (a) one or more data bus confinement corridors or (b) one or more storage bus confinement corridors.

22. The method of claim 21, wherein the sorting confinement site is coupled to the at least one of (a) one or more data bus confinement corridors or (b) one or more storage bus confinement corridors via a junction.

23. The method of claim 18, wherein the quantum object confinement apparatus comprises:
one or more confinement corridors, each confinement corridor of the one or more confinement corridors defined at least in part by respective corridor sequences of control electrodes, the one or more confinement corridors configured for transport of one or more quantum objects there along, wherein the originating location and the destination location are accessible via respective ones of the one or more confinement corridors; and
one or more sorting confinement sites, each sorting confinement site of the one or more sorting confinement sites defined at least in part by respective site sequences of control electrodes, each respective sorting confinement site of the one or more sorting confinement sites coupled to at least one respective confinement corridor such that one or more quantum objects may be transported from the at least one respective confinement corridor to the respective sorting confinement site and from the respective sorting confinement site to the at least one respective confinement corridor, wherein the one or more sorting confinement sites comprises the sorting confinement site.
